(19) United States
(12) Patent Application Publication
(10) Pub. No.: US 2026/0245206 A1
(43) Pub. Date: Aug. 20, 2026

(54) SYSTEM AND METHOD FOR DISEASE IDENTIFICATION

(71) Applicant: The Trustees of the Stevens Institute of Technology, Hoboken, NJ (US)

(72) Inventors: Ying Wang, West New York, NJ (US); Ishan Aryendu, Jersey City, NJ (US)

(21) Appl. No.: 19/539,572

(22) Filed: Feb. 13, 2026

Related U.S. Application Data
(60) Provisional application No. 63/758,665, filed on Feb. 14, 2025.

(51) Int. Cl. G06T 7/00; G06V 10/764; G06V 10/82; G06V 20/70

(52) U.S. Cl. CPC G06T 7/0012; G06V 10/764; G06V 10/82; G06V 20/70; G06T 2200/24; G06T 2207/10116; G06T 2207/20081; G06T 2207/20084; G06T 2207/30061; G06V 2201/03

(57) ABSTRACT

A method for identifying diseases in real time includes training an ensemble model to classify disease based on a plurality of lightweight models, wherein each lightweight model is trained to classify an individual disease based on chest x-ray (CXR) imaging, collecting and anonymizing one or more CXR images of a subject, labelling the one or more CXR images with one or more expert annotations, processing the one or more labelled CXR images with an image processing algorithm, classifying from the processed and labeled CXR images one or more diseases in the subject using the ensemble model, training an additional lightweight model if an unknown disease is classified, updating the ensemble model based on the additional lightweight model in real time, and identifying the unknown disease based on the updated ensemble model. A system for identifying diseases in real time is also described.

### CROSS-REFERENCE TO RELATED APPLICATIONS

This application claims priority to U.S. Provisional Patent Application No. 63/758,665, filed on Feb. 14, 2025, incorporated herein by reference in its entirety.

### BACKGROUND OF THE INVENTION

The rapid diagnosis of diseases using chest X-ray (CXR) images has been an active area of research, particularly during the COVID-19 pandemic. Several deep learning models, such as CheXpert and CheXNet, have demonstrated the potential for automatic detection of diseases like cardiomegaly, pneumonia, and pneumothorax from CXR images. These models have achieved diagnostic performance levels comparable to or exceeding those of practicing radiologists. However, they typically require centralized data aggregation, high computational resources, and extensive training data, which may not be feasible in resource-constrained environments or when patient data privacy is a concern.

Existing deep learning models for CXR diagnosis, such as DeepCOVID-XR, have shown high accuracy in detecting COVID-19 but are often complex and resource-intensive. They also require large datasets to train effectively, which can be challenging to obtain due to data privacy issues and the scarcity of labeled medical images. Furthermore, these models are typically inflexible and may not adapt well to new or emerging diseases without extensive retraining.

Thus, there is a need in the art for flexible models that do not require centralized data aggregation or high computational resources in order to identify and predict diseases while retaining patient privacy.

### SUMMARY OF THE INVENTION

A method for identifying diseases in real time includes training an ensemble model to classify disease based on a plurality of lightweight models, wherein each lightweight model is trained to classify an individual disease based on chest x-ray (CXR) imaging, collecting and anonymizing one or more CXR images of a subject, labelling the one or more CXR images with one or more expert annotations, processing the one or more labelled CXR images with an image processing algorithm, classifying from the processed and labeled CXR images one or more diseases in the subject using the ensemble model, training an additional lightweight model if an unknown disease is classified, updating the ensemble model based on the additional lightweight model in real time, and identifying the unknown disease based on the updated ensemble model.

In some embodiments, the ensemble model uses an adaptive meta-learning ensemble strategy to incorporate the predictions of the lightweight models. In some embodiments, the ensemble strategy comprises average voting (Avg. Voting), meta-learning approach using logistic regression (ML-LR), and decision trees (ML-DT).

In some embodiments, the method includes the step of anonymizing patient data and sending the CXR images, updated ensemble model, and additional lightweight model to a server comprising a global ensemble model and plurality of global lightweight models when an unknown disease is classified. In some embodiments, the method includes the step of synchronizing the ensemble model with a server-based ensemble model. In some embodiments, the method includes the step of synchronizing the plurality of lightweight models with a plurality of server-based lightweight models. In some embodiments, the method includes the step of alerting a physician when an unknown disease is identified.

In some embodiments, the additional lightweight model comprises geolocation data of the subject. In some embodiments, the method includes the step of alerting a physician based on geolocation data of the subject or physician when an unknown disease is classified. In some embodiments, the ensemble model operates on one or more convolutional neural networks (CNNs).

A system for identifying disease in real time includes a first computing device operating one or more models on one or more neural networks, wherein the one or more models comprise a first ensemble model combining the predictions of a first plurality of lightweight models, and wherein each lightweight model is trained to classify an individual disease based on chest x-ray (CXR) imaging, a second computing device communicatively connected to the first computing device configured to operate one or more models on one or more lightweight neural networks, wherein the one or more models comprise a second ensemble model and second plurality of lightweight models that synchronize with the one or more models of the first computing device, and wherein the second computing device is configured to receive and process labeled CXR images of a subject and classify one or more diseases in the subject with the second ensemble model.

In some embodiments, the second computing device identifies unknown diseases based on the processed labelled CXR images with the second ensemble model, and creates an additional lightweight model for the second plurality of lightweight models based on the classified unknown disease. In some embodiments, the second computing device sends the CXR images, the updated second ensemble model, and additional lightweight model to the first computing device when an unknown disease is classified. In some embodiments, the second computing devices anonymizes patient data before synchronizing the models with the first computing device.

In some embodiments, the system alerts a physician based on geolocation data of the subject or physician when an unknown disease is classified. In some embodiments, the system includes a graphical user interface (GUI) that provides real-time diagnostic data overlaying imaging of the subject. In some embodiments, the diagnostic data is displayed to a user with highlighted regions of interest on the imaging of the subject. In some embodiments, the GUI generates a confidence score associated with classification of the one or more diseases, the confidence score indicating a reliability of the classification based on outputs of the plurality of lightweight models. In some embodiments, the GUI suppresses one or more outputs of the plurality of lightweight models when the confidence score associated with the classification falls below a predetermined threshold. In some embodiments, the one or more neural networks comprise convolutional neural networks (CNNs).

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1 is a diagram depicting an exemplary Collaborative Ensembling Architecture employed by the disclosed system and method;

FIG. 2 is a diagram of an exemplary graphical user interface (GUI) of the present disclosure;

FIG. 3 is a flowchart showing the step-by-step process of an exemplary image enhancement process of the disclosed system and method;

FIG. 4A & FIG. 4B are exemplary architecture diagrams for SqueezeNet (FIG. 4A) and MobileNetV2 (FIG. 4B) models;

FIG. 5 is a Meta-learning model flowchart illustrating an exemplary step-by-step process starting with individual model predictions, stacking these predictions, and converting the target labels to a 1-D array. The meta-learning model is then trained and evaluated on the validation dataset, resulting in the final output;

FIG. 6 is a diagram depicting an exemplary method according to aspects of the present invention;

FIG. 7A & FIG. 7B are chest X-ray images of COVID-19 in a subject before (FIG. 7A) and after (FIG. 7B) applying CLAHE;

FIG. 8 is an exemplary set of 21 augmented X-Ray images for machine learning training. These augmented images, which include rotation, scaling, flipping, and cropping, improve the robustness of machine-learning models during training;

FIG. 9A, FIG. 9B, and FIG. 9C are a compilation of three sets of chest X-ray images for different health issues;

FIG. 10 is a plot showing the number of trainable parameters in each model used for ensembling in the literature;

FIG. 11A & FIG. 11B are plots showing a performance evaluation for the baseline models classifying COVID-19 and pneumonia using the accuracy (FIG. 11A) and loss (FIG. 11B) plots during the training and validation phases;

FIG. 12A & FIG. 12B are plots showing a performance evaluation of disease classification models for binary classification of the respiratory diseases using the accuracy (FIG. 12A) and loss (FIG. 12B) plots during training and validation phase using the seed models for ensemble learning;

FIGS. 13A & 13B is a diagram depicting an exemplary decision tree of the ensembling model used for image classification in the disclosed system and method, where the tree is color-coded to represent different classes of images: orange nodes correspond to the first class, green nodes to the second class, and purple nodes to the third class, and each node in the tree represents a decision point, depicting the path taken depending on the outcome of the decision;

FIG. 13C is a diagram depicting an exemplary decision tree of the ensembling model used for image classification in the disclosed system and method;

FIG. 14 is a set of matrices showing a comparative performance of various machine learning models in classifying Pneumonia and COVID-19, as depicted by the confusion matrices;

FIG. 15A & FIG. 15B are images showing a comparative visualization pneumonia diagnosis;

FIG. 16A & FIG. 16B are images showing a comparative visualization COVID-19 diagnosis;

FIG. 17A, FIG. 17B, FIG. 17C, and FIG. 17D are a series of X-ray images depicting post-training predictions with the actual and predicted labels after training; and

FIG. 18 is a diagram of an exemplary computing environment.

### DETAILED DESCRIPTION

It is to be understood that the figures and descriptions of the present invention have been simplified to illustrate elements that are relevant for a clear understanding of the present invention, while eliminating, for the purpose of clarity, many other elements found in related systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

Aspects of the present invention relate to computer software, computer systems and computer networks, and architectures thereof, that may comprise any number of computers (e.g., devices) and networking components that are communicatively coupled or connected. In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled or interpreted, including but not limited to C, C++, C#, Objective-C, Java, JavaScript, MATLAB, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, servers, tablets, smartphones, watches, wearable electronics or other wireless digital/cellular phones, televisions, cloud servers or instances, embedded microcontrollers, thin client devices, or any other suitable computing device known in the art. In some embodiments, the software operates across any number of far-edge, near-edge, and on-premises devices and/or components.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In some embodiments, elements of the networked portion of the invention may be implemented over a Virtual Private Network (VPN).

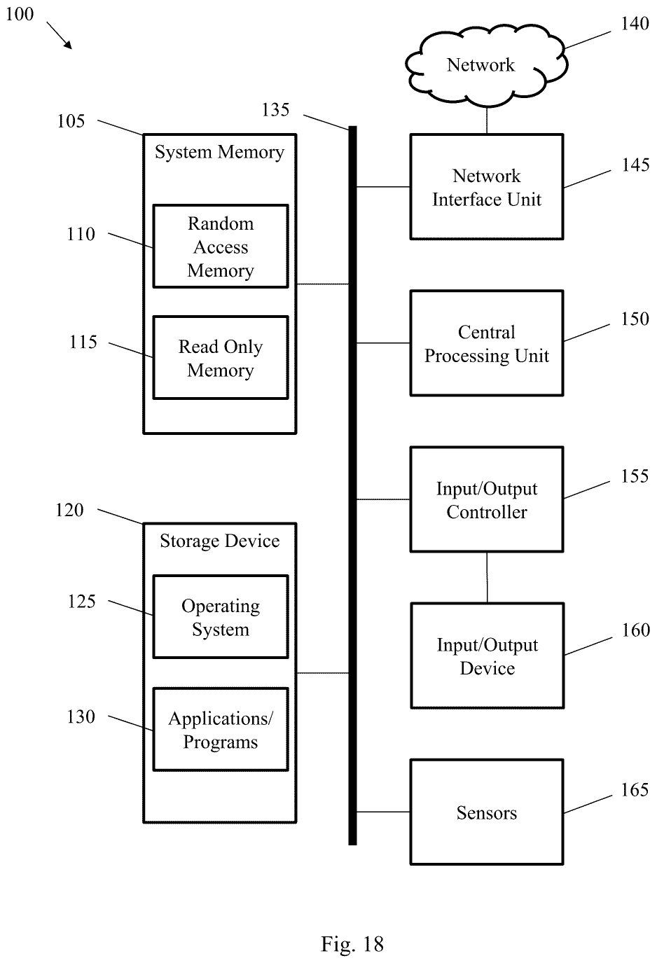

FIG. 18 and the following discussion are intended to provide a brief, general description of a suitable computing environment in which the invention may be implemented. While the invention is described above in the general context of program modules that execute in conjunction with an application program that runs on an operating system on a computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

FIG. 18 depicts an illustrative computer architecture for a computer 100 for practicing the various embodiments of the invention. The computer architecture shown in FIG. 18 illustrates a conventional personal computer, including a central processing unit 150 (“CPU”), a system memory 105, including a random access memory 110 (“RAM”) and a read-only memory (“ROM”) 115, and a system bus 135 that couples the system memory 105 to the CPU 150. A basic input/output system containing the basic routines that help to transfer information between elements within the computer, such as during startup, is stored in the ROM 115. The computer 100 further includes a storage device 120 for storing an operating system 125, application/program 130, and data.

The storage device 120 is connected to the CPU 150 through a storage controller (not shown) connected to the bus 135. The storage device 120 and its associated computer-readable media provide non-volatile storage for the computer 100. Although the description of computer-readable media contained herein refers to a storage device, such as a hard disk or CD-ROM drive, it should be appreciated by those skilled in the art that computer-readable media can be any available media that can be accessed by the computer 100.

By way of example, and not to be limiting, computer-readable media may comprise computer storage media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the computer 100 may operate in a networked environment using logical connections to remote computers through a network 140, such as TCP/IP network such as the Internet or an intranet. The computer 100 may connect to the network 140 through a network interface unit 145 connected to the bus 135. It should be appreciated that the network interface unit 145 may also be utilized to connect to other types of networks and remote computer systems. In some embodiments, the computer architecture may physically reside in medical equipment found in hospitals and surgical suites, or may be otherwise communicatively coupled with the medical equipment.

The computer 100 may also include an input/output controller 155 for receiving and processing input from a number of input/output devices 160, including medical equipment found in hospitals and surgical suites such as cameras and imaging equipment, or more generally a keyboard, a mouse, a display, a touchscreen, a handheld phone, a camera, a microphone, a controller, a joystick, or other type of input device. Similarly, the input/output controller 155 may provide output to a display screen, a printer, a speaker, or other type of output device. The computer 100 can connect to the input/output device 160 via a wired connection including, but not limited to, fiber optic, Ethernet, or copper wire or wireless means including, but not limited to, Wi-Fi, Bluetooth, Near-Field Communication (NFC), infrared, or other suitable wired or wireless connections.

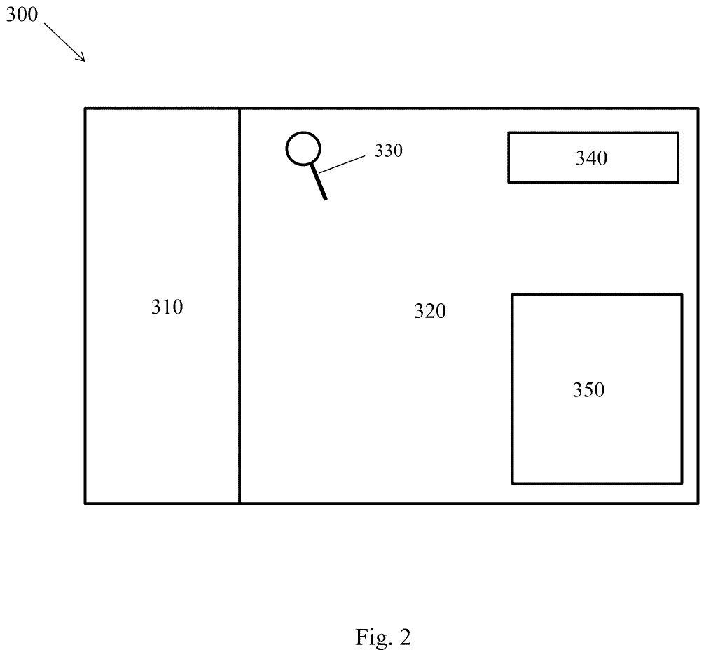

As mentioned briefly above, a number of program modules and data files may be stored in the storage device 120 and/or RAM 110 of the computer 100, including an operating system 125 suitable for controlling the operation of a networked computer. The storage device 120 and RAM 110 may also store one or more applications/programs 130. In particular, the storage device 120 and RAM 110 may store an application/program 130 for providing a variety of functionalities to a user. For instance, the application/program 130 may comprise many types of programs such as a word processing application, a spreadsheet application, a desktop publishing application, a database application, a gaming application, internet browsing application, electronic mail application, messaging application, and the like. According to an embodiment of the present invention, the application/program 130 comprises a multiple functionality software application for providing word processing functionality, slide presentation functionality, spreadsheet functionality, database functionality and the like. In some embodiments, computer 100 operates a software that produces a user interface (UI) or graphical user interface (GUI), as discussed herein and shown in FIG. 2.

The computer 100 in some embodiments can include a variety of sensors 165 for monitoring the environment surrounding the computer 100. These sensors 165 can include sensors deployed in medical equipment found in hospitals and surgical suites such as cameras and imaging equipment, or other sensors such as a Global Positioning System (GPS) sensor, a photosensitive sensor, a gyroscope, a magnetometer, thermometer, a proximity sensor, an accelerometer, a microphone, biometric sensor, barometer, humidity sensor, radiation sensor, or any other suitable sensor.

In some embodiments, the disclosed system and method utilize machine learning algorithms and models, and one or more neural networks, that may operate on at least one computing device or computer (e.g., computer 100). In some embodiments, the disclosed system comprises one or more of any neural network known by one of ordinary level of skill in the art, including but not limited to convolutional neural networks (CNNs) and deep neural networks (DNNs). In some embodiments, more than one neural network is synchronized or replicated across multiple computer devices, and may include networks that are lightweight representations of full models residing on a server or in the cloud.

The present disclosure addresses limitations of existing systems and methods by employing a distributed, privacy-preserving learning architecture that allows for on-site model training using anonymized chest X-ray (CXR) data. This approach reduces the need for data sharing and enables rapid adaptation to new disease conditions without the extensive computational resources typically required by conventional models. Additionally, the use of lightweight models like MobileNetV2 and SqueezeNet makes the system suitable for deployment on low-power devices, enhancing its applicability in diverse and resource-limited settings.

The disclosed system and method leverages a multi-tiered system architecture to efficiently diagnose chest X-ray images at the edge, while preserving patient privacy. In some embodiments, the system and method employs multiple lightweight prediction models optimized to differentiate between various respiratory conditions. These models may operate across far-edge, near-edge, and on-premises components, enabling rapid feature extraction and model training without immediate output constraints. The system incorporates an innovative ensembling strategy that combines meta-learning and predictive outputs to provide real-time ensemble learning. This allows for quick and accurate disease classification without the need for extensive computational resources or large datasets. Additionally, the architecture supports decentralized and scalable deployment, balancing the need for high-speed diagnostics with robust data privacy measures, making it particularly useful for rapid diagnostics during pandemics or in resource-limited environments.

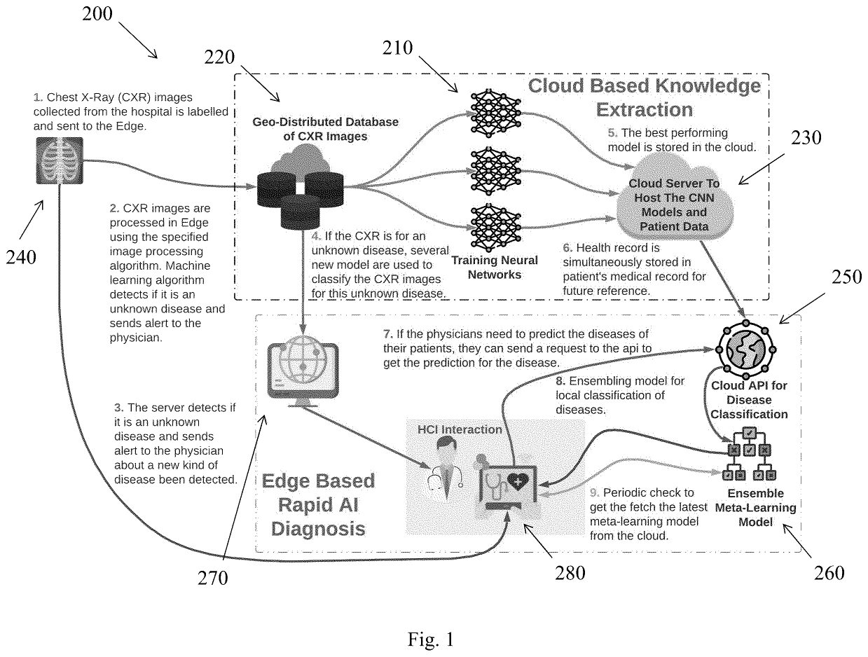

FIG. 1 is a diagram depicting an exemplary system 200 for real time identification of disease comprising a Collaborative Ensembling Architecture. In some embodiments, system 200 comprises any number of computers or devices (e.g., computer 100) hosting any number of neural networks and/or models, each device communicatively connected or coupled to a network. For example, a plurality of training neural networks 210 coupled to a geo-distributed database of CXR images 220 and cloud server 230. In some embodiments, database of CXR images 220 is configured to receive labeled CXR images 240 collected in a hospital or other healthcare facility. In some embodiments, cloud server 230 is coupled to Cloud API 250 comprising an ensemble meta-learning model 260. In some embodiments, system 200 comprises a computing device 270 that displays images or results 280 from system 200. After preprocessing of CXR images 240 at the edge, these images are analyzed using a local ensembling model that combines predictions from multiple models. These models are periodically synchronized with the latest meta-learning models from the cloud server 230 to keep them fresh. Physicians can interactively transmit CXR images 240 and obtain disease classification results 280 through this local model, facilitating rapid diagnosis in clinical communication (HCI Communication). When an unknown disease is detected, images are sent to the cloud server 230 for further analysis and new modeling, ensuring system 200 adapts to emerging health risks.

In a non-limiting example, a system 200 for identifying disease in real time comprises a first computing device operating one or more models on one or more neural networks, wherein the one or more models comprise a first ensemble model combining the predictions of a first plurality of lightweight models, and wherein each lightweight model is trained to classify an individual disease based on chest x-ray (CXR) imaging, and a second computing device communicatively connected to the first computing device configured to operate one or more models on one or more lightweight neural networks, wherein the one or more models comprise a second ensemble model and second plurality of lightweight models that synchronize with the one or more models of the first computing device, and wherein the second computing device is configured to receive and process labeled CXR images of a subject and classify one or more diseases in the subject with the second ensemble model. In some embodiments, the one or more neural networks comprise convolutional neural networks (CNNs).

In some embodiments, system 200 identifies unknown diseases based on the processed labelled CXR images and the second ensemble model and creates an additional lightweight model for the second plurality of lightweight models based on the classified unknown disease. In some embodiments, the second computing device sends the CXR images, the updated second ensemble model, and additional lightweight model to the first computing device when an unknown disease is classified. In some embodiments, the second computing devices anonymizes patient data before synchronizing the models with the first computing device. In some embodiments, the system alerts a physician based on geolocation data of the subject or physician when an unknown disease is classified. In some embodiments, system 200 further comprises a graphical user interface (GUI) that provides real-time diagnostic data overlaying imaging of the subject. In some embodiments, the diagnostic data is displayed to a user with highlighted regions of interest on the imaging of the subject.

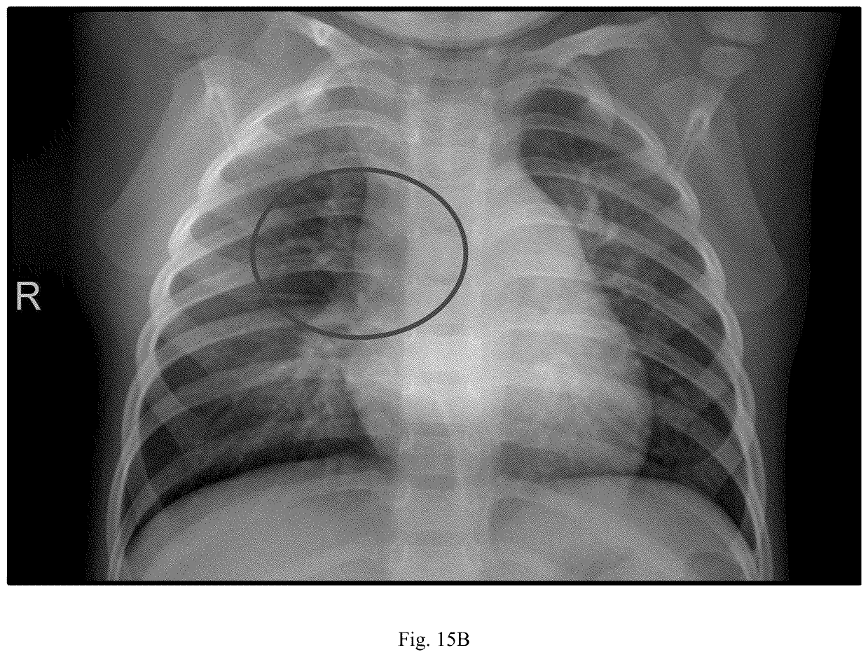

FIG. 2 is a diagram of an exemplary graphical user interface (GUI) of the present disclosure that may comprise one or more dashboards. In some embodiments, a system as disclosed herein may comprise a software producing a graphical user interface (GUI). FIG. 2 depicts an exemplary dashboard 300 for the GUI comprising a navigation bar 310 and content area 320. In some embodiments, dashboard 300 further comprises a search tool 330 and drop down menu or selector 340 (e.g., a content and/or outcome selector). In some embodiments, dashboard 300 provides one or more tabs and/or lists with organized widgets, modules, alerts, graphs, and/or reports displayed in content area 320 of the GUI that provides patient-related medical data and diagnosis. The GUI is configured to displays imaging, data and results of the disclosed system and method for real-time disease prediction. This includes any imaging, patient data, imaging data and associated results as produced by the disclosed system and method. For example, the GUI may produce a heatmap and visual indicators overlayed over patient imaging (such as in FIG. 15B), or any number of comparisons or results, such as confidence scores or ratings, for any produced diagnosis or identification. For example, in some embodiments, the GUI generates a confidence score associated with classification of the one or more diseases, the confidence score indicating a reliability of the classification based on outputs of the plurality of lightweight models. In some embodiments, the GUI suppresses one or more outputs of the plurality of lightweight models when the confidence score associated with the classification falls below a predetermined threshold. Further, the GUI can produce location-based medical information, data and/or results based on existing, new and/or emerging diseases and trends thereof. In some embodiments, the GUI produces predictions of future disease for one or more geolocations based on historical data and newly classified and/or predicted diseases.

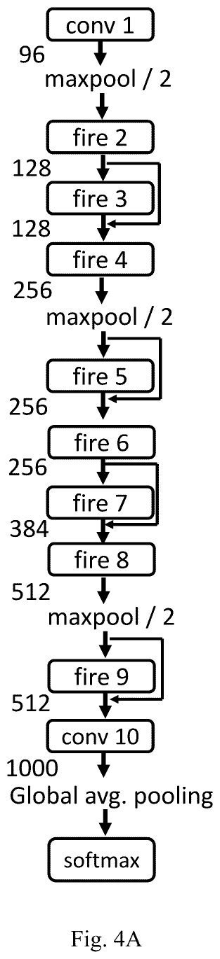

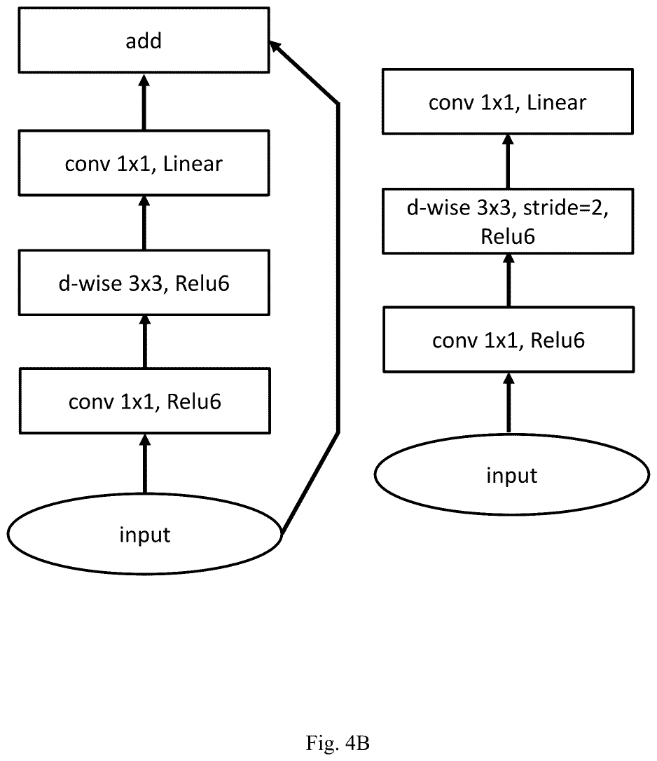

FIG. 4A & FIG. 4B are exemplary architecture diagrams for SqueezeNet (FIG. 4A) and MobileNetV2 (FIG. 4B) models.

The disclosed system and method has at least the following advantages over existing technologies in the field.

Distributed and Scalable Architecture: Unlike traditional deep learning models that rely heavily on centralized data and computing resources, the disclosed system and method introduces a distributed architecture that enables training and diagnosis across far-edge, near-edge, and on-premises devices. This structure allows for efficient utilization of resources while maintaining data privacy, offering flexibility that conventional systems lack.

Lightweight Models with High Performance: The use of lightweight models such as MobileNetV2 and SqueezeNet significantly reduces computational requirements, allowing for deployment on low-power devices, for example embedded computing platforms including but not limited to the Raspberry Pi and Intel NUC. Traditional models often require powerful GPUs and extensive memory, making them unsuitable for edge computing scenarios.

Meta-Learning and Ensemble Strategy: The system employs a novel meta-learning approach combined with an ensemble strategy to enhance diagnostic accuracy and adaptability. This technique allows the model to quickly integrate new data and adapt to emerging diseases without extensive retraining, which is a limitation in many existing deep learning frameworks that require large datasets and extensive retraining for each new condition.

On-Site Training and Privacy Preservation: The disclosed system and method address privacy concerns by enabling on-site training, thereby reducing the need to share sensitive patient data across locations. This is a significant improvement over traditional methods that often require centralized data storage and processing, which can be a bottleneck in terms of both data privacy and compliance.

Flexibility in Handling Resource Constraints: By selecting and optimizing models that are not data-hungry and can run effectively on devices with limited computational power, the disclosed system and method allow for deployment in resource-constrained environments. Traditional methods often fail to balance performance and computational requirements, making them less versatile in real-world applications

The disclosed system and method have the following advantages:

Rapid and Efficient Diagnosis in Resource-Constrained Environments: Traditional deep learning models for medical image diagnosis often require powerful computational resources and large datasets, making them unsuitable for deployment in resource-constrained environments. The disclosed system and method overcome this limitation by employing lightweight models optimized for low-power devices such as Raspberry Pi and Intel NUC. This ensures that rapid diagnosis can be performed even in remote or under-resourced areas, thus expanding access to timely and accurate medical evaluations.

Privacy-Preserving Data Processing: Conventional diagnostic systems typically centralize data processing, raising concerns about patient privacy and data security. The disclosed system and method address these issues by enabling on-site model training, minimizing the need to share sensitive patient data across locations. This approach not only ensures compliance with data protection regulations but also reduces the risks associated with data breaches and unauthorized access.

Scalable and Decentralized System Architecture: The multi-tiered architecture of the system allows for decentralized deployment and scaling across various geographic locations. This enables collaborative learning from diverse data sources, enhancing the system's ability to generalize and adapt to different medical conditions, even in the face of emerging diseases or pandemics.

Meta-Learning for Adaptability and Reduced Data Dependence: Unlike conventional models that require large amounts of labeled data for each new disease, the disclosed system utilizes meta-learning to quickly adapt to new conditions with minimal data. This reduces the burden of data collection and labeling, making it easier to deploy in new contexts or for novel disease detection without extensive retraining.

Enhanced Diagnostic Accuracy and Speed: The ensemble learning strategy employed by the system combines the strengths of multiple lightweight models, providing higher diagnostic accuracy and faster response times compared to individual models. This is particularly advantageous in high-pressure situations like pandemics, where rapid and reliable diagnostic capabilities are critical for effective healthcare delivery.

The disclosed system and method differ from existing technology:

Privacy-Preserving Distributed Learning: Unlike traditional centralized deep learning models that require extensive data aggregation, the disclosed system and method enable privacy-preserving distributed learning. The system utilizes a decentralized architecture where models are trained locally on anonymized chest X-ray images and synchronized periodically with global models. This approach mitigates privacy concerns associated with sharing sensitive patient data while still enabling effective model training and adaptation.

Adaptive Meta-Learning Ensemble Strategy: Most existing systems use static model configurations that require retraining for new diseases or updated datasets. The disclosed system and method employ an adaptive meta-learning ensemble strategy, allowing it to incorporate new data dynamically and respond to emerging health threats without the need for extensive retraining. This flexibility contrasts with the rigid training processes of traditional models, enhancing the system's responsiveness and scalability.

Lightweight Model Deployment on Low-Power Devices: Traditional deep learning systems often depend on high-performance GPUs and large-scale computing resources, making them impractical for deployment in low-resource settings. The disclosed system and method leverage lightweight models like MobileNetV2 and SqueezeNet, optimized for deployment on low-power devices such as Raspberry Pi and Intel NUC. This enables real-time diagnosis in resource-constrained environments, significantly expanding the reach of diagnostic capabilities.

Comprehensive Image Processing Techniques: Unlike previous systems and methods that may rely on basic image preprocessing, the disclosed system and method employ advanced techniques such as Contrast Limited Adaptive Histogram Equalization (CLAHE) and median filtering. These methods and techniques enhance image quality and diagnostic accuracy, addressing common challenges in medical image interpretation such as noise and varying image resolutions.

Rapid Deployment and Scalability: The system's design allows for rapid deployment and scaling across different geolocations. It supports the collaborative training and validation of models across multiple specialized sites, enabling quicker adaptation to new disease variants or changes in diagnostic requirements. This is a significant improvement over existing models that often require centralized training and extensive data collection before deployment.

Unique features of the disclosed technology include:

Multi-Tiered Architecture: The system is designed with a multi-tiered architecture that includes far-edge, near-edge, and on-premises predictive components. This allows for extensive feature extraction and model training without immediate output constraints, providing flexibility in deployment and rapid diagnosis capabilities across various resource environments.

Lightweight Meta-Learning Ensembling: The system and method utilize an innovative ensembling strategy that incorporates meta-learning to combine predictive outputs from multiple lightweight models. This dual-structured ensembling provides real-time ensemble learning for prompt and request-oriented classification while maintaining the integrity of prior training. This reduces computational complexity and improves efficiency in real-time diagnostics.

Scalability and Privacy Preservation: The system's architecture is decentralized and scalable, balancing rapid feature extraction and efficient classification with robust data privacy measures. It supports the training of models on-site, leveraging local data for model refinement while preserving patient confidentiality, making it suitable for rapid deployment in large-scale health emergencies like pandemics

Deployment Flexibility with Diverse Computing Resources: The system can be deployed across different computing environments, from high-performance servers to low-power IoT devices. This is achieved through careful optimization of lightweight prediction models like MobileNetV2 and SqueezeNet, enabling effective operation even in resource-constrained settings

Real-time Model Synchronization and Adaptation: The architecture supports real-time synchronization of models between local and cloud systems. When an unknown disease is detected, the system can adapt by updating the models based on new data, ensuring continuous improvement and responsiveness to emerging health threats.

Exemplary processes and steps of the disclosed system and method comprise:

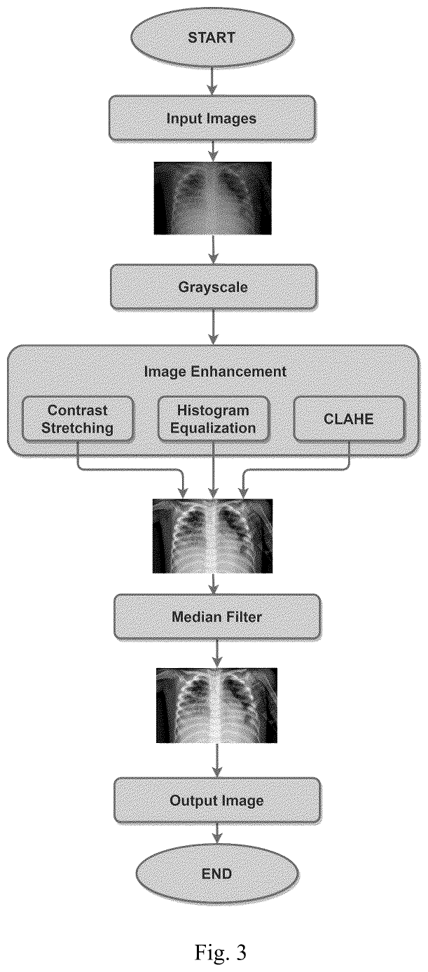

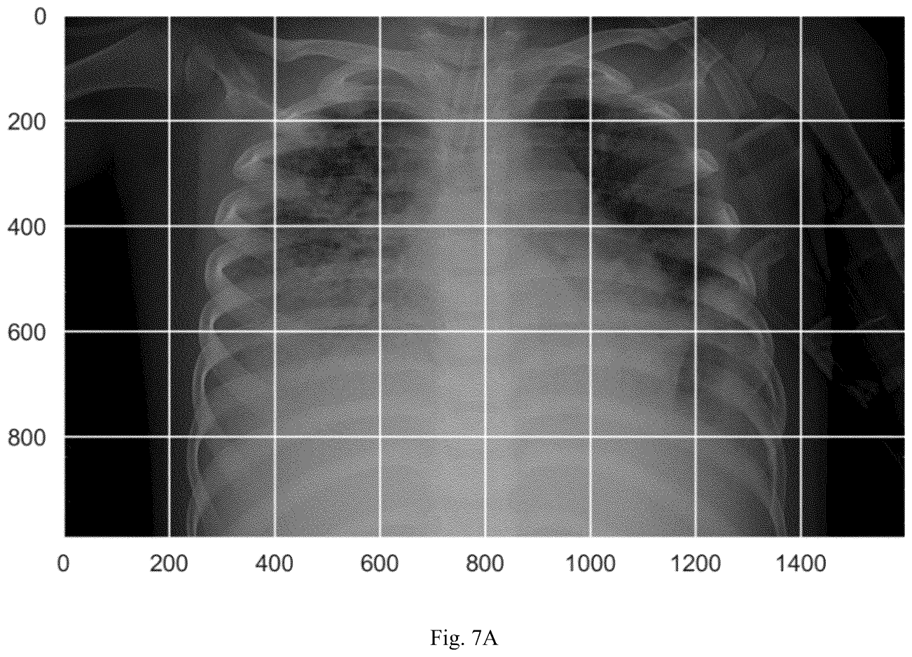

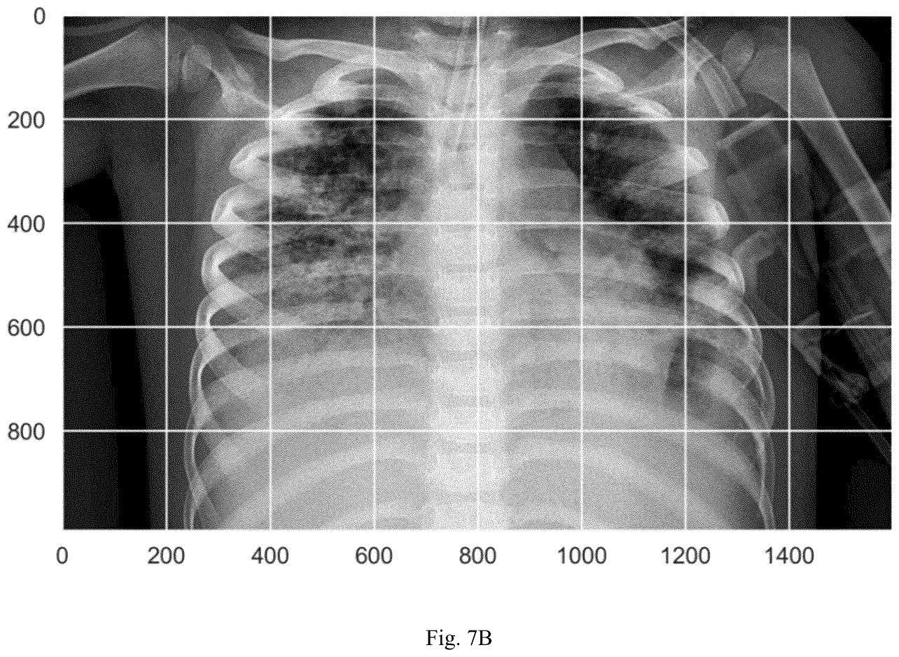

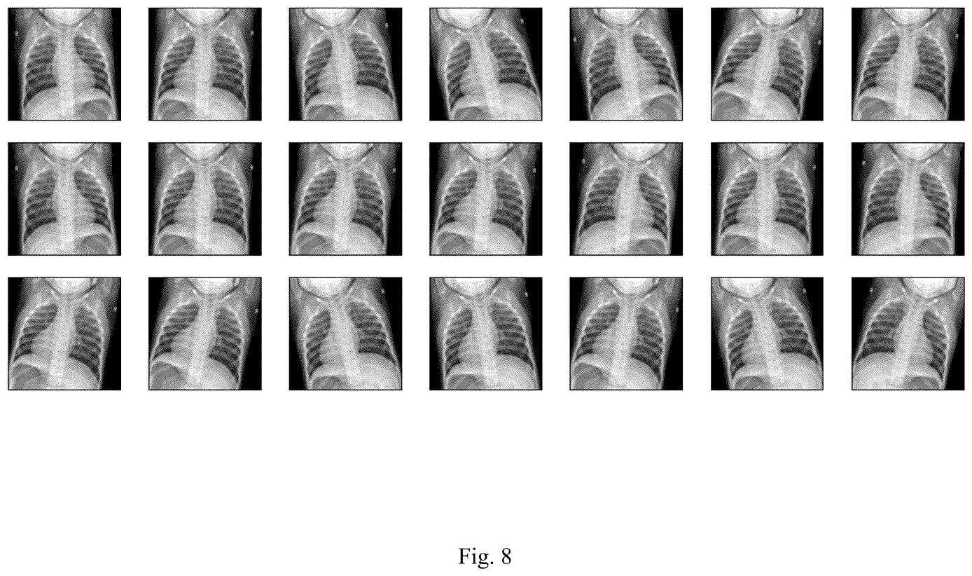

Data Collection and Preprocessing: Regularly collect chest X-ray (CXR) images labeled by specialists based on patients' medical conditions. These images are processed either on-premises or sent to edge servers. Apply preprocessing techniques such as grayscale conversion, contrast stretching, and contrast-limited adaptive histogram equalization (CLAHE) to enhance image quality. This prepares the data for efficient feature extraction and model training. FIG. 3 is a flowchart showing the step-by-step process of an exemplary image enhancement process of the disclosed system and method. Starting with the grayscale conversion of input images, CLAHE is applied and then the images further refined using a median filter, resulting in the final output image. FIG. 7A & FIG. 7B are chest X-ray images of COVID-19 in a subject before and after applying CLAHE.

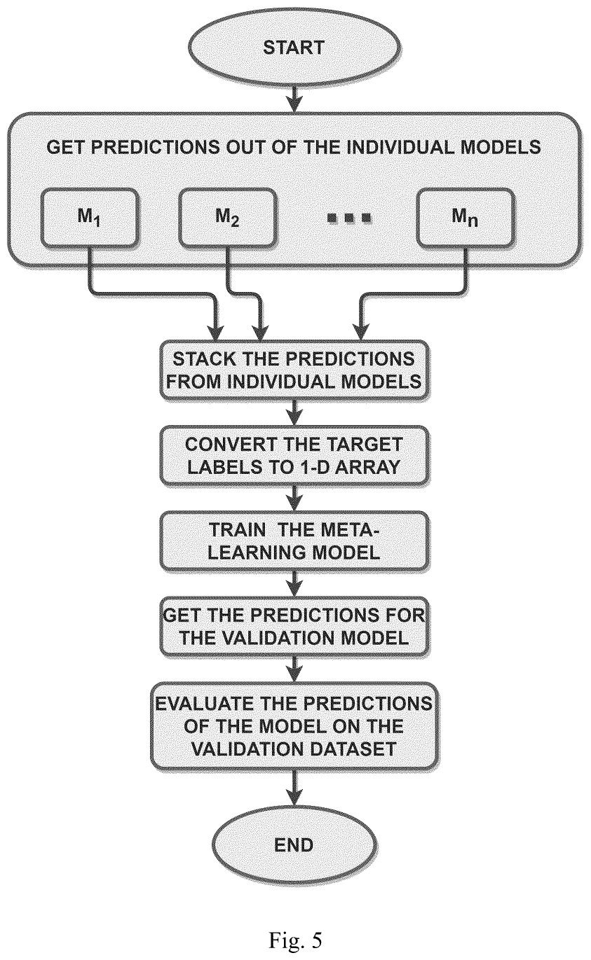

Model Training and Ensembling: The disclosed system and method train multiple lightweight prediction models like MobileNetV2 and SqueezeNet on far-edge servers to differentiate between various respiratory conditions. Further, an ensemble learning strategy is implemented that integrates predictions from these models using meta-learning. This approach leverages the strengths of individual models to enhance overall diagnostic accuracy. FIG. 5 is a Meta-learning model flowchart illustrating an exemplary step-by-step process starting with individual model predictions, stacking these predictions, and converting the target labels to a 1-D array. The meta-learning model is then trained and evaluated on the validation dataset, resulting in the final output. FIG. 8 is an exemplary set of 21 augmented X-Ray images for machine learning training. These augmented images, which include rotation, scaling, flipping, and cropping, improve the robustness of machine-learning models during training.

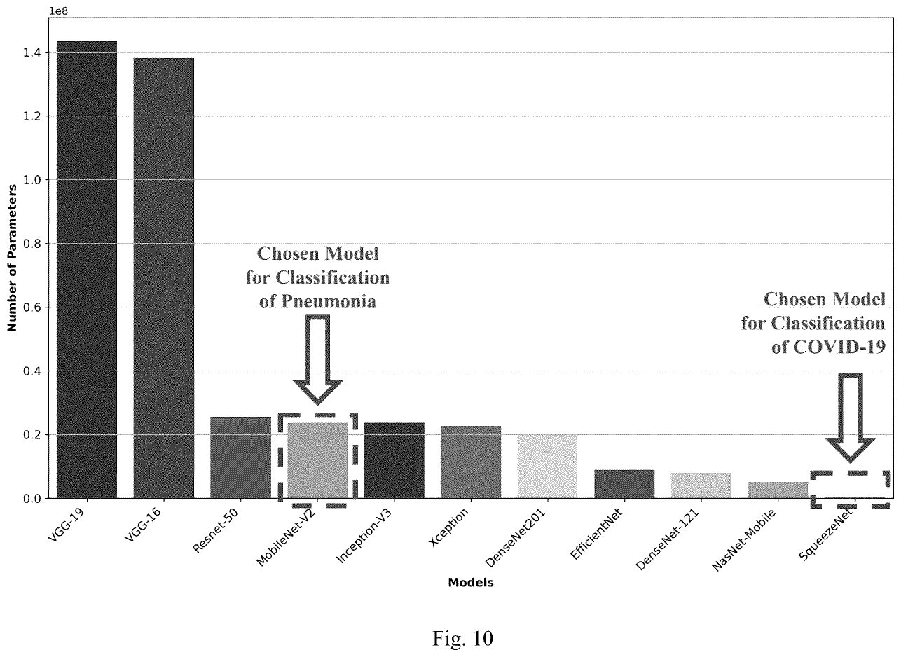

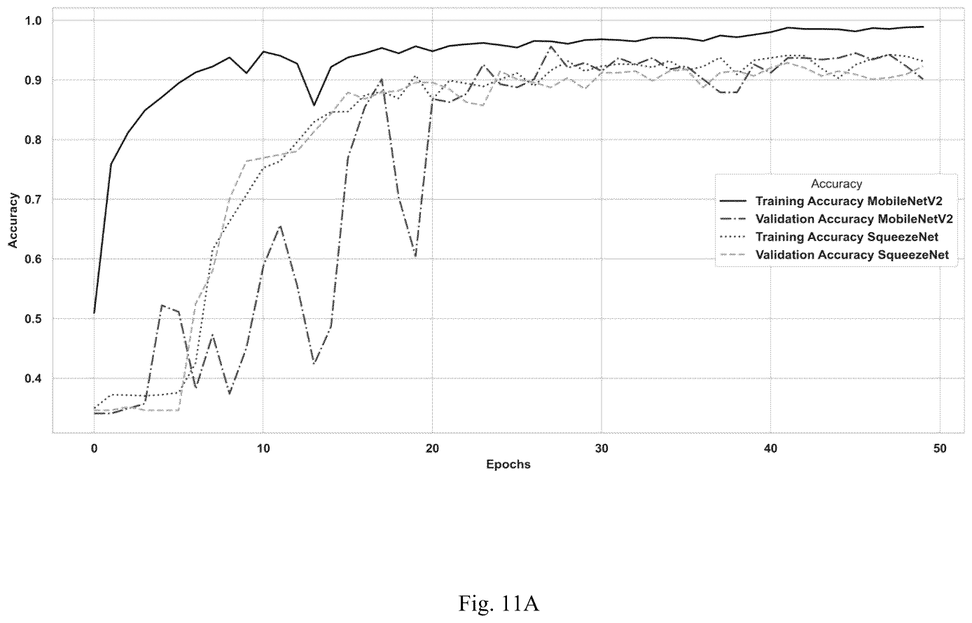

The disclosed system and method utilize ensemble learning and meta-learning to enhance the accuracy of respiratory disease diagnosis using lightweight CNN models, specifically MobileNetV2 and SqueezeNet. These models are trained on far-edge servers to differentiate between conditions such as, but not limited to, COVID-19, viral pneumonia, and normal lung states, leveraging datasets like MIMIC-CXR and COVIDGR. To improve robustness, the system and method employ data augmentation techniques, including, but not limited to, rotation, scaling, flipping, and cropping-ensuring adaptability to variations in medical imaging (see FIG. 10 for the number of trainable parameters in each model). Predictions from individual models are stacked and integrated using meta-learning, allowing for optimized diagnostic accuracy while reducing computational demand. By deploying this framework on edge devices, the disclosed system and method support privacy-preserving, real-time diagnosis, minimizing reliance on centralized computing. Additionally, the system is periodically synchronized with cloud-based meta-learning models, enabling rapid adaptation to new respiratory diseases without the need for extensive retraining. This approach ensures scalability and efficiency, making it particularly beneficial for resource-constrained settings and large-scale diagnostic applications.

Model Synchronization and Update: The disclosed system and method periodically synchronize models between local edge devices and cloud servers to ensure they are updated with the latest data and models. This helps the system adapt to new disease classes and improves diagnostic performance over time.

Privacy Preservation and Decentralized Deployment: The disclosed system and method utilize on-site training and encryption techniques to maintain patient privacy and confidentiality. Data remains decentralized, minimizing the need to transfer sensitive information across networks.

Real-Time Diagnosis and Feedback: In some embodiments, the disclosed system and method deploy trained models on edge devices to provide real-time diagnostic results. In some embodiments, physicians can interactively transmit CXR images and obtain disease classification results through the local ensembling model. If a novel disease is detected, alerts are sent to physicians within the network for timely response.

The disclosed system is designed to identify and classify respiratory diseases using real-time edge-based AI diagnosis. The primary conditions it can detect include COVID-19 (including variants), viral pneumonia, lung opacity, pleural effusion, and other abnormalities observable in chest X-rays. The system utilizes lightweight CNN models (MobileNetV2 and SqueezeNet) trained on datasets like MIMIC-CXR and COVIDGR, enabling rapid and accurate classification with high sensitivity and specificity. For novel disease identification, the system employs meta-learning and ensemble methods, which allow it to generalize and adapt to new conditions by aggregating predictions from multiple models. If an unknown pathology is detected, the system can flag the case, generate alerts, and distribute the findings across the physician network for further evaluation. This decentralized approach ensures timely response to emerging diseases, making the system well-suited for pandemic preparedness and large-scale medical diagnostics in resource-limited settings.

Adaptation and Continuous Learning: When an unknown disease is detected, the system updates its models based on new data, allowing for continuous improvement and adaptation to emerging health threats. This ensures the system remains effective in rapidly changing clinical environments.

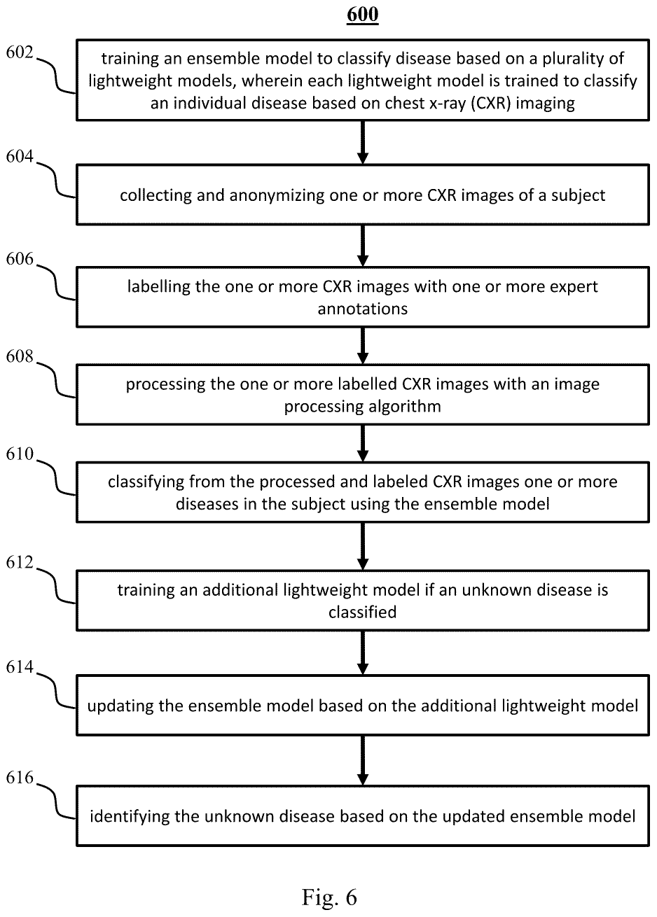

FIG. 6 is a diagram depicting an exemplary method for identifying disease in real-time according to aspects of the present invention. In a non-limiting example, method 600 for identifying disease in real-time comprises the steps of 602 training an ensemble model to classify disease based on a plurality of lightweight models, wherein each lightweight model is trained to classify an individual disease based on chest x-ray (CXR) imaging, 604 collecting and anonymizing one or more CXR images of a subject, 606 labelling the one or more CXR images with one or more expert annotations, 608 processing the one or more labelled CXR images with an image processing algorithm, 610 classifying from the processed and labeled CXR images one or more diseases in the subject using the ensemble model, 612 training an additional lightweight model if an unknown disease is classified, 614 updating the ensemble model based on the additional lightweight model and 616 identifying the unknown disease based on the updated ensemble model.

Method 600 described above outlines the disclosed system's real-time disease identification process, leveraging ensemble learning and meta-learning for adaptive diagnostics. The method generally includes training lightweight models (MobileNetV2, SqueezeNet) for specific diseases, anonymizing and preprocessing CXR images, applying expert annotations, and using an ensemble classification model to enhance accuracy. Additionally, the system dynamically updates by training new lightweight models when an unknown disease is detected, integrating them into the ensemble for improved identification.

In some embodiments, further contemplated steps for method 600 comprise: Automated Quality Control: Implementing image enhancement techniques such as contrast-limited adaptive histogram equalization (CLAHE) to improve diagnostic accuracy. Federated Learning for Continuous Improvement: Updating local models without sharing raw patient data, ensuring privacy while improving classification performance across multiple locations. Automated Alert System: Notifying physicians in real time when a novel disease pattern is detected, enabling early intervention in case of emerging health threats. Confidence Score Calibration: Providing uncertainty estimates for classification results, allowing clinicians to assess reliability and prioritize further analysis. These additional steps further enhance scalability, privacy preservation, and adaptability for rapid and reliable medical diagnostics.

In some embodiments, the ensemble model uses an adaptive meta-learning ensemble strategy to incorporate the predictions of the lightweight models. In some embodiments, the ensemble strategy comprises average voting (Avg. Voting), meta-learning approach using logistic regression (ML-LR), and decision trees (ML-DT). In some embodiments, The determination of the optimal strategy is performed via a decision tree to identify the best-performing ensembling strategy. In some embodiments, the method further comprises the step of anonymizing patient data and sending the CXR images, updated ensemble model, and additional lightweight model to a server comprising a global ensemble model and plurality of global lightweight models when an unknown disease is classified. In some embodiments, the anonymization step is designed to remove Personally Identifiable Information (PII) to ensure patient privacy. In some embodiments, the method further comprises the step of synchronizing the ensemble model with a server-based ensemble model. The synchronization step ensures that users are aware of all models corresponding to the diseases in the database. In some embodiments, the method further comprises the step of synchronizing the plurality of lightweight models with a plurality of server-based lightweight models. In some embodiments, the method further comprises the step of alerting a physician when an unknown disease is classified. In some embodiments, the additional lightweight model comprises geolocation data of the subject. In some embodiments, the method further comprises the step of alerting a physician based on geolocation data of the subject or physician when an unknown disease is classified. In some embodiments, the ensemble model operates on one or more convolutional neural networks (CNNs).

The disclosed system and method use several publicly available datasets, such as MIMIC-CXR, COVIDGR, and BIMCV, which consist of a wide variety of chest X-ray images. These datasets provide images with various resolutions and contain data on different respiratory conditions, including COVID-19 and viral pneumonia. The models trained on these datasets, such as MobileNetV2 and SqueezeNet, are used to validate the performance of the proposed system.

In addition to MIMIC-CXR, COVIDGR, and BIMCV, the disclosed system can incorporate and validate models using other publicly available chest X-ray datasets to enhance robustness and adaptability for detecting various respiratory diseases. Potential datasets for future integration include: ChestX-ray14, CheXpert, VinDr-CXR, RSNA Pneumonia Detection Challenge Dataset. In some embodiments, the disclosed system and method can leverage private institutional datasets and federated learning frameworks to improve model generalization across diverse patient demographics while maintaining privacy-preserving training on distributed medical data.

This disclosed system and method can be applied to underrepresented areas that lack rapid chest X-ray-based medical diagnostics. It leverages existing infrastructure and edge computing to provide rapid and privacy-preserving chest X-ray diagnosis. With the disclosed meta-learning based rapid detection, the method does not require high-power computing resources and is not data-intensive for training on both existing and new diseases. This system can be particularly beneficial for rapid and large-scale diagnosis in case of pandemics in the future, offering a scalable solution for timely and accurate medical evaluations in resource-constrained settings.

The disclosed system, while designed for rapid chest X-ray diagnostics, can be extended to other medical imaging-based diseases, particularly in resource-constrained settings. Its meta-learning and edge computing approach minimizes computational and data requirements, making it applicable to conditions beyond respiratory diseases. For instance, it can support stroke detection (MRI/CT), breast and lung cancer screening (mammography, CT), cardiovascular disease diagnosis (echocardiography, CT angiography), and musculoskeletal disorders (X-ray/MRI for fractures or arthritis). Additionally, it can assist in gastrointestinal imaging, such as liver disease detection (ultrasound, MRI) or polyp identification (colonoscopy). By adapting to multiple imaging modalities, this system enables scalable, rapid, and privacy-preserving diagnostics for emerging diseases and large-scale screenings, particularly in pandemics and low-resource regions.

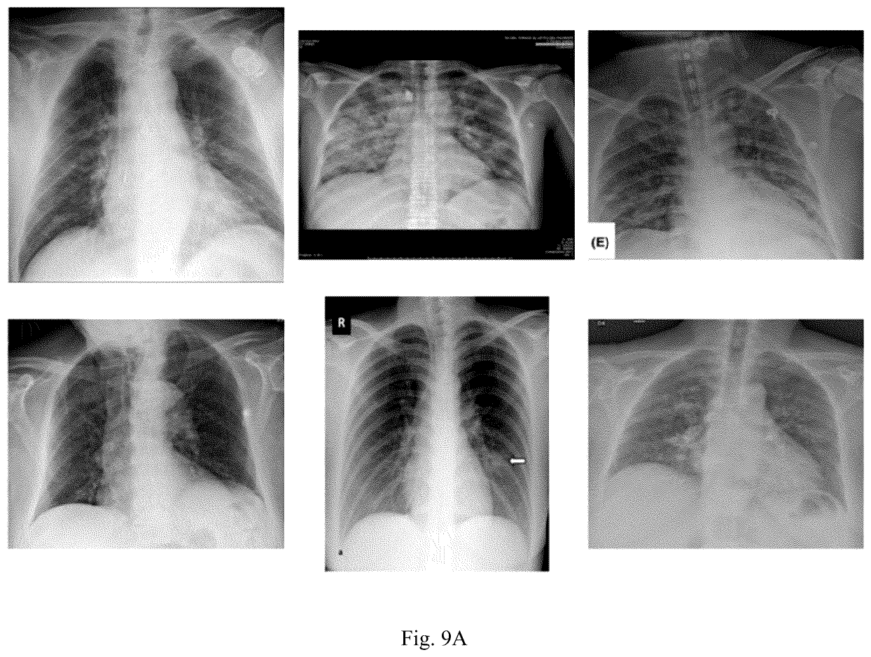

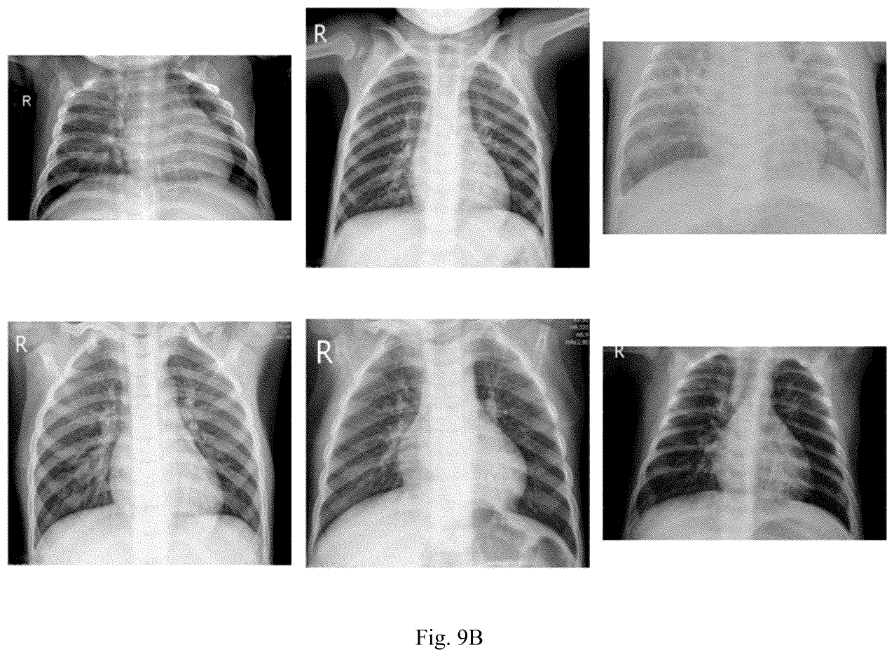

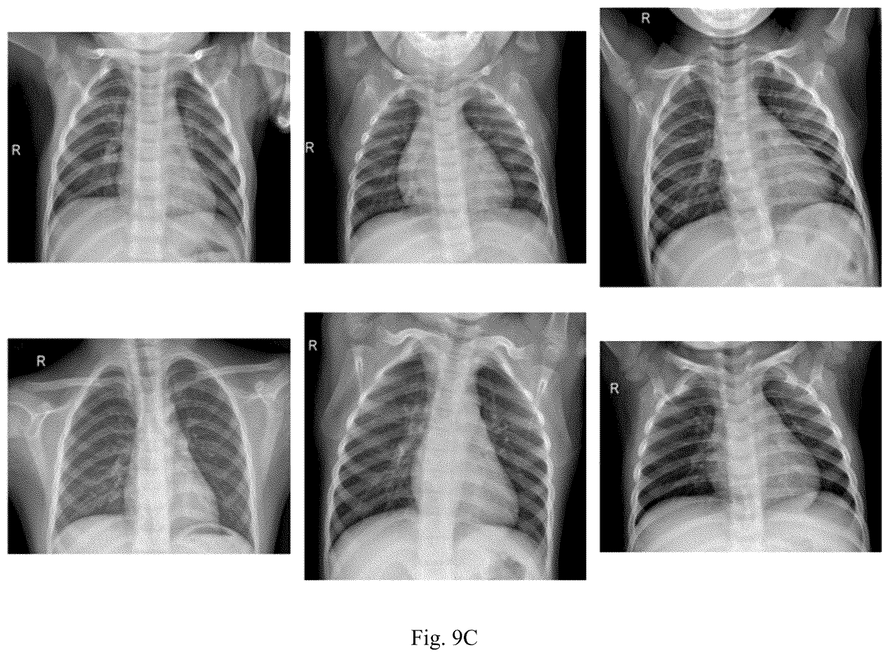

FIG. 9A, FIG. 9B, and FIG. 9C are a compilation of three sets of chest X-ray images for different health issues. The first set (FIG. 9A) represents the X-rays of patients suffering from COVID-19. The second set (FIG. 9B) represents the X-rays of patients suffering from viral pneumonia. The last set (FIG. 9C) includes X-rays of healthy individuals without any sickness.

FIG. 10 is a plot showing the number of trainable parameters in each model used for ensembling in the literature.

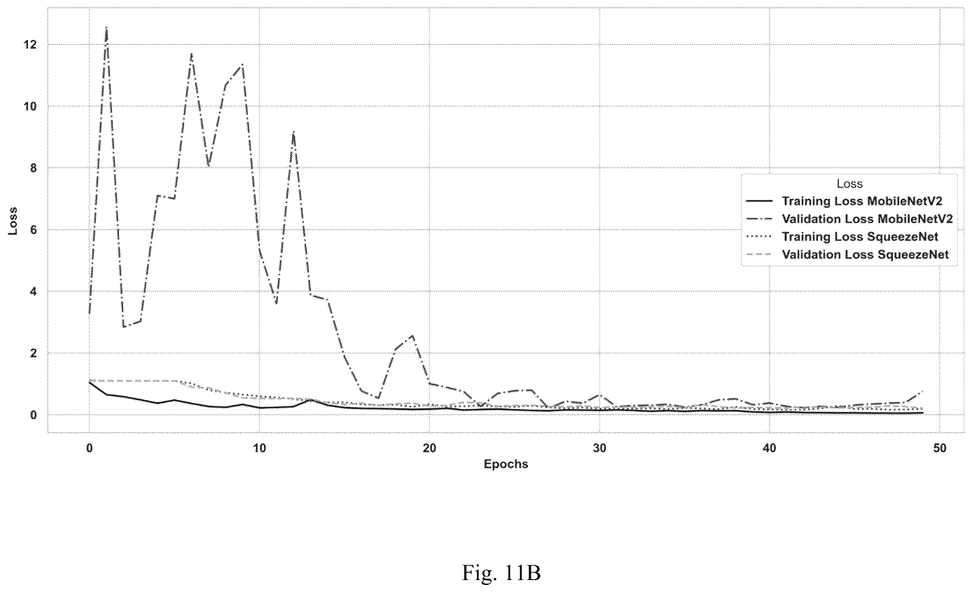

FIG. 11A & FIG. 11B are plots showing a performance evaluation for the baseline models classifying COVID-19 and pneumonia using the accuracy and loss plots during the training and validation phases.

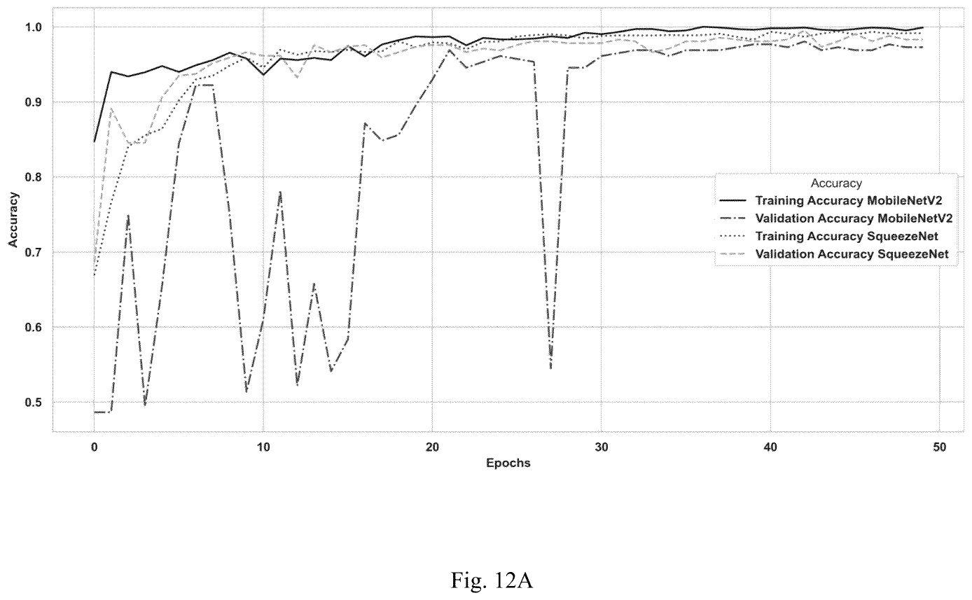

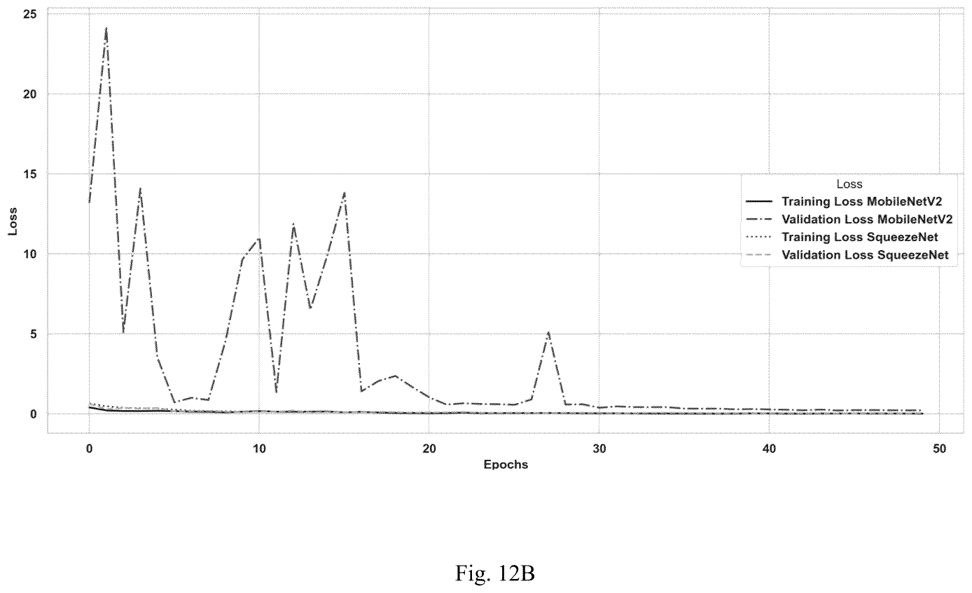

FIG. 12A & FIG. 12B are plots showing a performance evaluation of disease classification models for binary classification of the respiratory diseases using the accuracy and loss plots during training and validation phase using the seed models for ensemble learning.

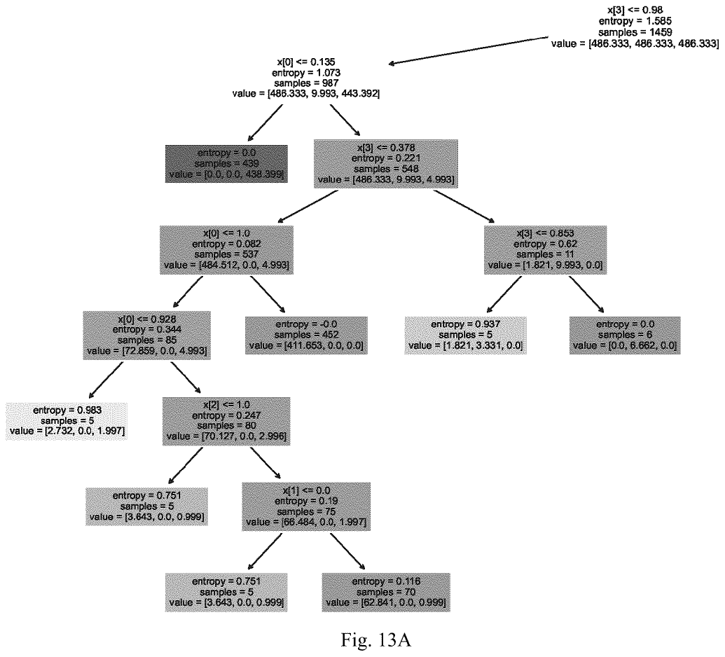

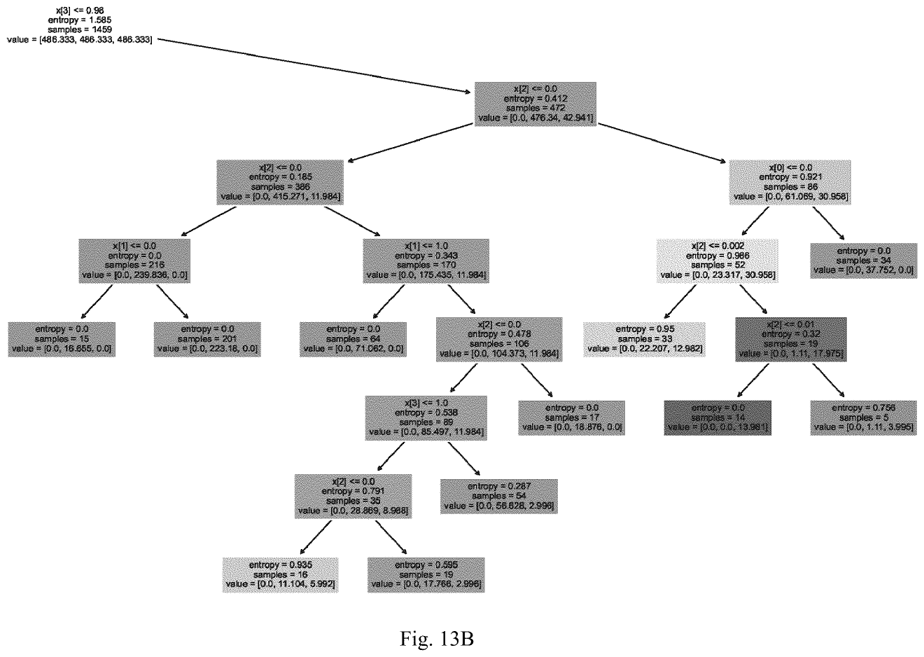

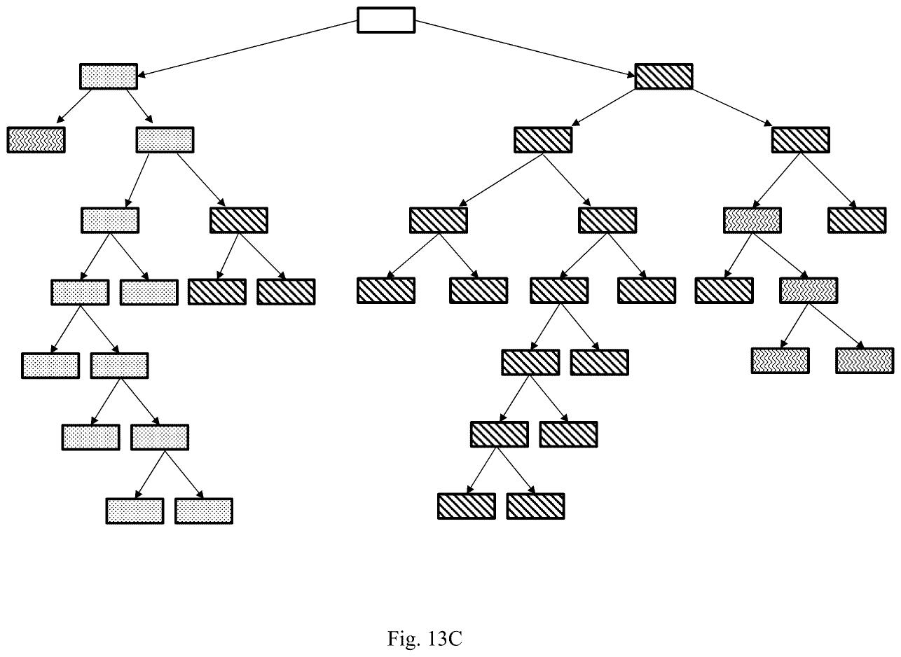

FIGS. 13A & 13B is a diagram depicting an exemplary decision tree of the ensembling model used for image classification in the disclosed system and method, where the tree is color-coded to represent different classes of images: orange nodes correspond to the first class, green nodes to the second class, and purple nodes to the third class, and each node in the tree represents a decision point, depicting the path taken depending on the outcome of the decision.

FIG. 13C is a diagram depicting an exemplary decision tree of the ensembling model used for image classification in the disclosed system and method. The tree is patterned to represent different classes of images: dotted nodes correspond to the first class, diagonal line nodes to the second class, and zig zag nodes to the third class. Each node in the tree represents a decision point, depicting the path taken depending on the outcome of the decision.

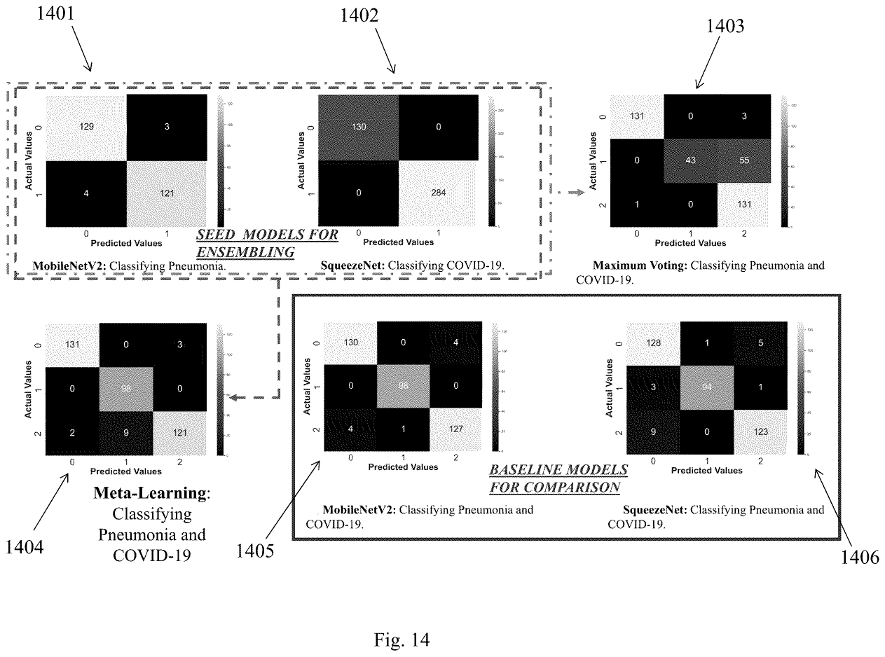

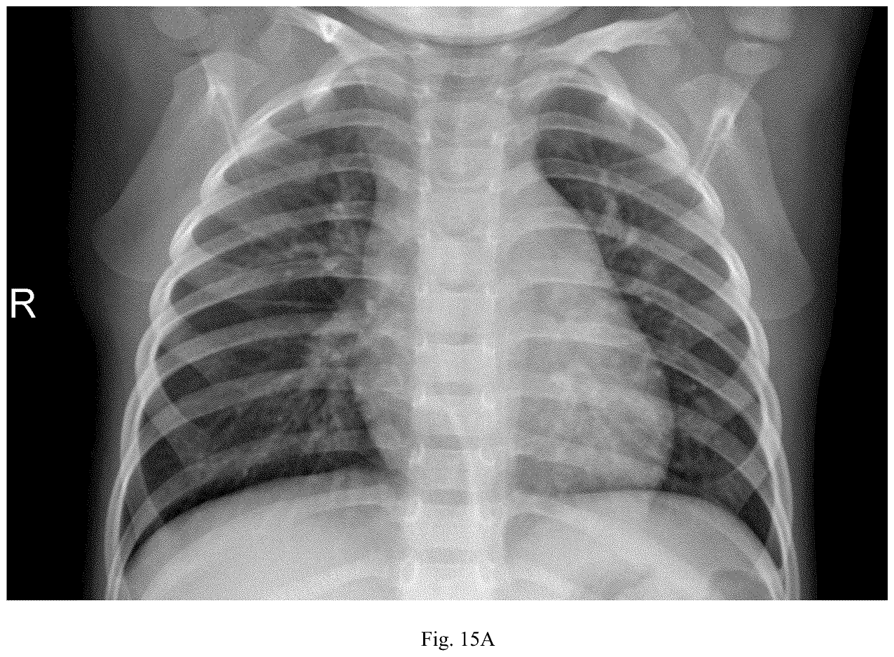

FIG. 14 is a set of matrices showing a comparative performance of various machine learning models in classifying Pneumonia and COVID-19, as depicted by the confusion matrices. Each matrix provides a detailed breakdown of true positives, true negatives, false positives, and false negatives, offering a comprehensive view of each model's predictive accuracy and error rate. The models are categorized into three groups: (matrix 1401, matrix 1402) Seed models (MobileNetV2 and SqueezeNet) trained on individual disease tasks to generate probability matrices for ensemble learning; (matrix 1403) Maximum voting ensemble method combining predictions from seed models; (matrix 1404) Meta-learning approach leveraging seed model outputs for joint disease classification. (matrix 1405, matrix 1406) Baseline models (MobileNetV2 and SqueezeNet) trained for simultaneous pneumonia and COVID-19 prediction. The meta-learning model (matrix 1404) and standalone MobileNetV2 (matrix 1406) emerge as the top-performing techniques, accurately classifying most cases across all disease classes.

FIG. 15A & FIG. 15B are images showing a comparative visualization pneumonia diagnosis. FIG. 15A depicts an unprocessed X-ray of a lung belonging to a person who tested positive for Pneumonia. FIG. 15B depicts the highlighted GRAD-CAM heat map labeling the important parts of the lung that the model considers to be important for predicting Pneumonia.

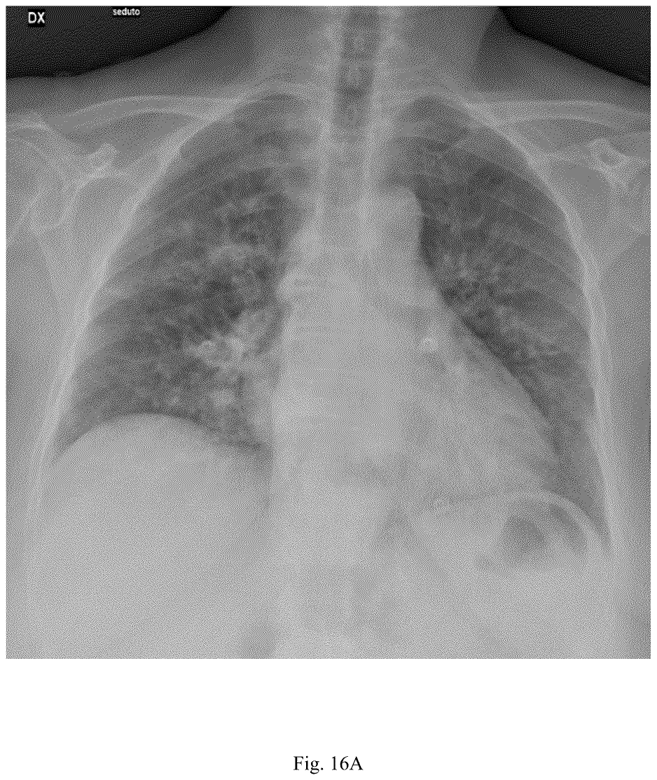

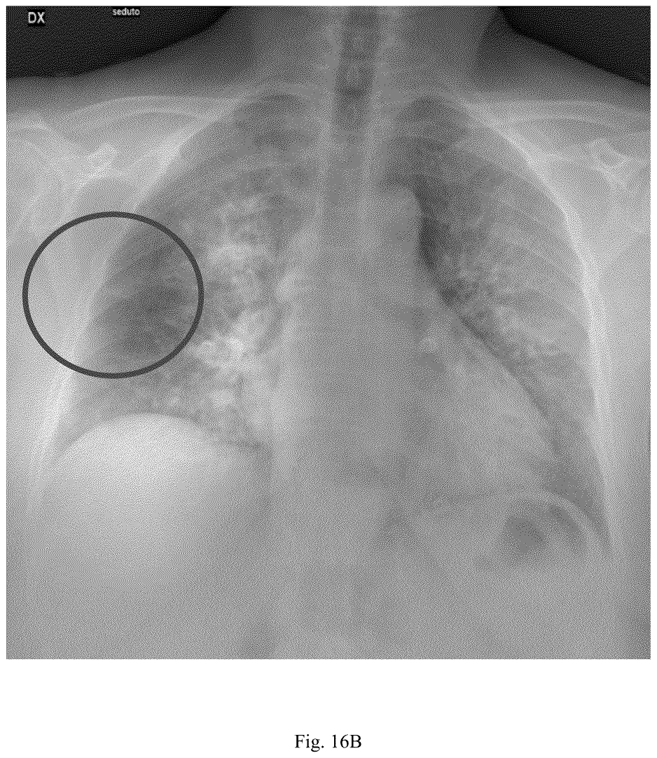

FIG. 16A & FIG. 16B are images showing a comparative visualization COVID-19 diagnosis. FIG. 16A depicts an unprocessed X-ray of a lung belonging to a person who tested positive for COVID-19. FIG. 16B depicts the highlighted GRAD-CAM heat map labeling the important parts of the lung that the model considers to be important for predicting COVID-19.

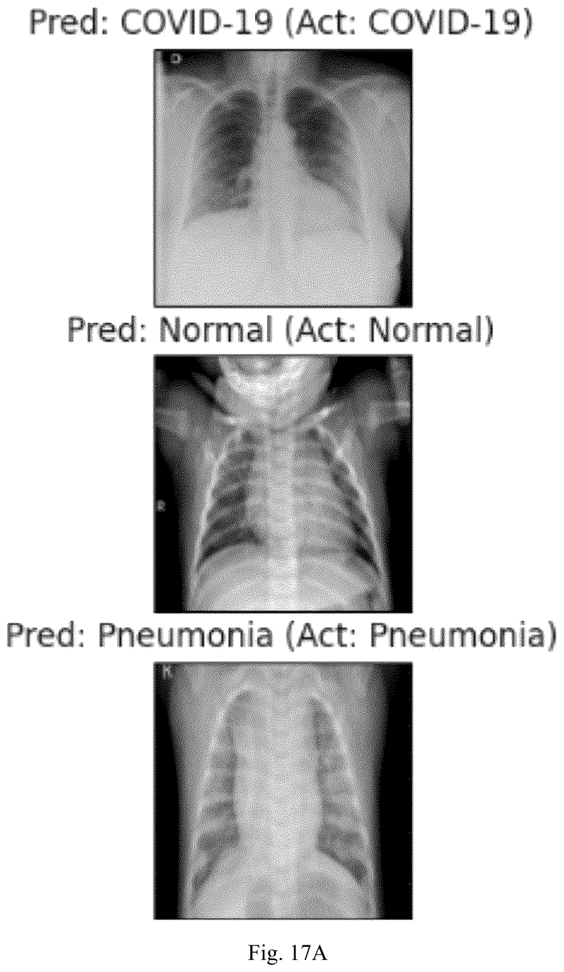

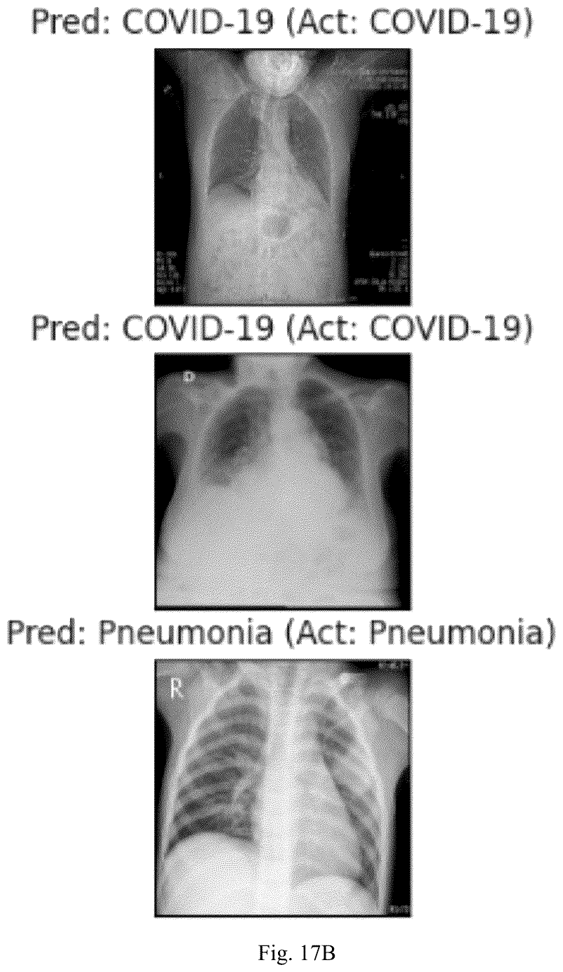

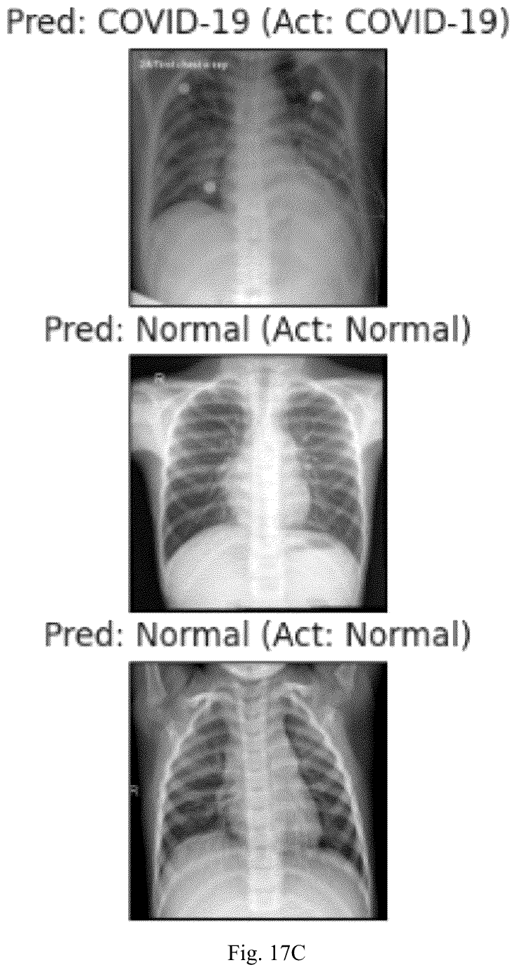

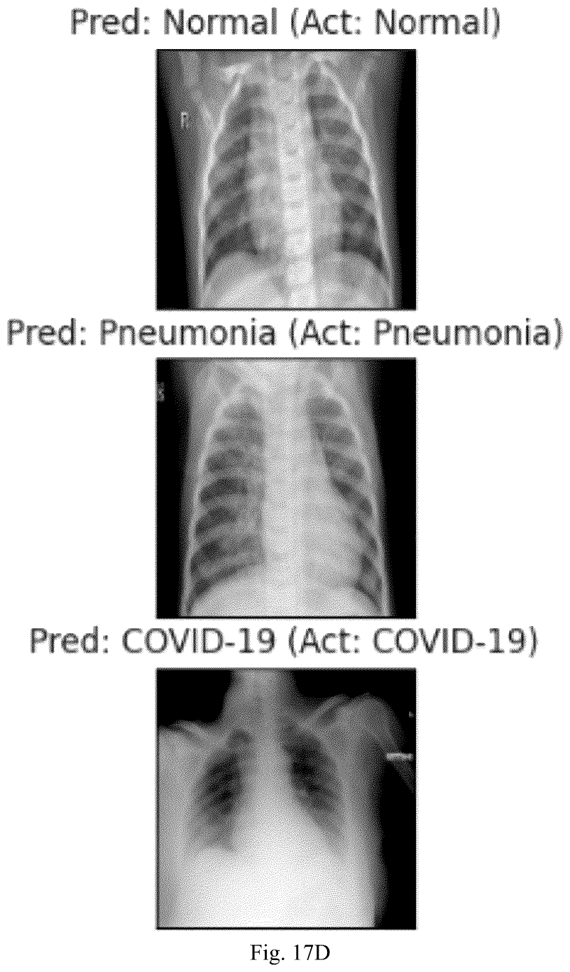

FIG. 17A, FIG. 17B, FIG. 17C, and FIG. 17D are a series of X-ray images depicting post-training predictions with the actual and predicted labels after training. The diversity of predictions across various conditions demonstrates the model's ability to differentiate between multiple diseases, underscoring its effectiveness in diagnosis.

The following publications are incorporated by reference:

Leveraging GANs to Improve Continuous Path Keyboard Input Models [Mehra, Akash, et al., ICASSP 2020-2020 IEEE International Conference on Acoustics, Speech and Signal Processing (ICASSP). IEEE, 2020.]: This reference discusses the use of Generative Adversarial Networks (GANs) for improving the performance of keyboard input models. It highlights the privacy-preserving capabilities of GANs in handling user data securely without revealing sensitive information.

Learning with Privacy at Scale: Differential Privacy Team, Apple [Apple, 2020, Available at: machinelearning.apple.com/research/learning-with-privacy-at-scale]: This paper by Apple's Differential Privacy Team explores methodologies for implementing privacy at scale using differential privacy techniques. It emphasizes the importance of maintaining user data confidentiality while enabling large-scale machine learning model training.

Privacy at Scale: Local Differential Privacy in Practice [Cormode, Graham, et al. “Privacy at scale: Local differential privacy in practice.” Proceedings of the 2018 International Conference on Management of Data. 2018.]: This work delves into the practical implementation of local differential privacy, focusing on how it can be utilized in real-world scenarios to protect individual data during the collection and processing stages.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the system and method of the present invention. The following working examples therefore, specifically point out the exemplary embodiments of the present invention, and are not to be construed as limiting in any way the remainder of the disclosure.

### RAIDER: Rapid AI Diagnosis at Edge Using Ensemble Models for Radiology

The disclosed system and method (e.g., RAIDER) has been thoroughly tested experimentally to validate its effectiveness. The primary experiments involved training and testing lightweight models, such as MobileNetV2 and SqueezeNet, on a dataset of chest X-ray images representing various conditions including COVID-19, viral pneumonia, and healthy cases are disclosed herein. The models were trained using 1470 images and validated on 368 images. Several ensembling strategies, such as average voting and meta-learning with logistic regression (ML-LR) and decision trees (ML-DT), were employed to improve diagnostic accuracy.

Key Findings: Performance Metrics: The ensemble models achieved high diagnostic performance with accuracy, sensitivity, specificity, F1-score, and AUC values of 97.80%, 97.06%, 98.48%, 96.51%, and 0.9739, respectively, outperforming traditional RT-PCR tests for COVID-19 detection, which typically show sensitivity between 60%-70%. Resource Efficiency: The system was tested on various devices, including high-power desktop servers, Intel NUC, and Raspberry Pi 5, demonstrating effective performance even on resource-constrained hardware. This confirms its suitability for deployment in real-world, resource-limited environments. Model Adaptability: The ensemble learning approach proved effective in adapting to new data and providing robust diagnostics without extensive retraining, making it suitable for rapid deployment during health crises such as pandemics. The experimental results show that the proposed system can provide accurate, scalable, and privacy-preserving diagnostics, making it a valuable tool for healthcare applications. Further experimental data is disclosed herein.

Chest X-rays have played an indispensable part in medical diagnosis for several decades. However, there is a scarcity of experts who can interpret these images to diagnose critical illnesses, which can lead to preventable fatalities. This example discloses Rapid AI Diagnosis at Edge using Ensemble Models for Radiology (RAIDER) designed to leverage the advantages of cross-geolocation meta-learning models. Using the disclosed system and method, local machine learning models are generated at individual locations and distributed across other locations for diagnosing diseases at the edge or on-premises if required before they become worldwide pandemics, significantly enhancing the rapid or near-real-time identification of fast-spreading respiratory diseases through online learning. The disclosed approach allows for geo-distributed multi-fold model training, harnessing the unique strengths of diverse geographical data sources to improve diagnostic accuracy and speed by leveraging edge computing. Using existing Convolutional Neural Network (CNN) models and distributed training at the edge, the accuracy and cost-effectiveness of diagnosis can be enhanced. The disclosed system architecture allows for distributed training and independently verified performance metrics on the MIMIC-CXR and COVIDGR chest X-ray datasets with accuracy, sensitivity, specificity, F1-score and AUC of 97.80%, 97.06%, 98.48%, 96.51%, and 0.9739, respectively. The disclosed RAIDER architecture marks the first implementation of a collaborative framework that facilitates seamless interaction across different geographic locations and edge computing, enabling a more effective and efficient response to emerging health threats.

Humans live in a tender world with a struggling health infrastructure to care for the ever-growing population on the planet. The fragile nature of society was on full display at the onset of the rapid spread of COVID-19, which caused a global pandemic a few years ago [J. Wojtusiak et al., in Proc. IEEE 9th Int. Conf Healthcare Informat. (ICHI), August 2021, pp. 347-356.]. The hospitals were swamped with hundreds of thousands of patients, requiring swift diagnosis to prevent overcrowding and further spread of diseases. Since then, several COVID-19 variants like Beta, Delta, and Omicron have caused global public health concerns in the following years due to their resistance to the existing vaccines [P. D. Yadav et al., J. Travel Med., vol. 28, no. 7, October 2021, Art. no. taab104.] as they were less susceptible to neutralization by antibodies generated by previous infection or existing vaccination. In light of these events, the critical infrastructure supporting rapid diagnosis has attracted significant attention [Y. Wang et al., in Proc. 15th Int. Joint Conf Biomed. Eng. Syst. Technol. (BIOSTEC)—HEALTHINF, Setúbal, Portugal: SciTePress, 2022, pp. 491-498.], [Y. Wang and T. Liao, in Proc. IEEE Int. Conf E-Health Netw., Appl. Services (HealthCom), October 2022, pp. 142-148.]. While real-time reverse transcription-polymerase chain reaction (RT-PCR) is the most widely used method, it takes a long time [Y. Yi et al., Int. J. Biol. Sci., vol. 16, no. 10, pp. 1753-1766, 2020.], [Y. Wang and J. Wojtusiak, Bethesda, ML, USA: AMIA, 2021.], and has a sensitivity of only 60%-70%, meaning that it is crucial to have commercial kits available in order to test positive in about 30% of situations when the test result is negative [B. Udugama et al., ACS Nano, vol. 14, no. 4, pp. 3822-3835, April 2020.]. Although there are several alternatives for diagnosing patients with COVID-19, chest X-ray images have particularly proven useful in assessing the severity of the disease. Several research studies have explored the effectiveness and the potential of using machine learning models for interpreting these images. Interpreting a chest radiograph can present difficulties because of the superimposed anatomical structures along the projection path. This phenomenon may pose significant challenges in terms of identifying anomalies in specific areas like a nodule posterior to the heart on a frontal CXR [L. G. B. A. Quekel et al., Eur. J. Radiol., vol. 39, no. 2, pp. 111-116, August 2001.], detecting minute or subtle abnormalities, or precisely differentiating between various pathological patterns. For these reasons, analysis of CXR pictures by radiologists is often subject to considerable interobserver variability. Several deep learning models have been presented that detect COVID-19 with high accuracy [F. Shi et al., Phys. Med. Biol., vol. 66, no. 6, March 2021, Art. no. 065031.], [T. Ozturk et al., Comput. Biol. Med., vol. 121, June 2020, Art. no. 103792.]. Nevertheless, these models are enormous, complex to scale, and expensive to train. They also require large datasets of images to detect subtle differences in the medical images, which need more nuanced image enhancements and complex models to detect these features as the number of diseases to classify grows. When a new COVID-19 variant emerges, the associated symptoms and protocols for diagnosing the disease via chest X-rays may change. Additionally, several other diseases also rely on chest X-rays for diagnosis [G. Bonito et al., BJR|Open, vol. 5, no. 1, November 2023, Art. no. 20220011.]. In addition, the current supervised training of deep neural networks on medical image diagnosis relies heavily on large pools of labeled data, which is scarce, inflexible, expensive, and limited by types of annotations. Since chest X-rays are private and confidential data, they can only be shared with other researchers with proper anonymization and approval. However, anonymizing and using the data on-site to train the classification models is more straightforward. As conventional computer-aided diagnosis systems face significant hurdles in adapting to the rapid spreading of new strains of this disease, a more flexible and decentralized approach is needed to keep pace with the rapid spread of such infectious and life-threatening diseases. Using such an approach, one can standardize the image preprocessing steps and share the machine learning models without sharing the patients' private data. Furthermore, the approach would be scalable and enable collaboration across different geographic locations to quickly detect novel diseases and their variants.

Researchers worldwide have used Chest X-ray images to assess and diagnose several health issues in patients, including assessing the condition of the lungs, heart-related problems, detecting the size and outline of the heart, blood vessels, calcium deposits, fractures, postoperative changes, the presence of a pacemaker, defibrillator or catheter, and several combinations of these. Several deep learning models trained on publicly available labeled chest X-ray datasets are available for detecting these illnesses. For example, CheXpert can automatically detect the presence of 13 diseases in radiology reports [J. Irvin et al., 2019, arXiv:1901.07031.], including Enlarged Cardiom, Cardiomegaly, Lung Lesion, Lung Opacity, Edema, Consolidation, Pneumonia, Atelectasis, Pneumothorax, Pleural Effusion, Fracture, Support Devices, and more. Similarly, CheXNet can also detect 14 diseases but outperforms CheXpert in terms of accuracy [P. Rajpurkar et al., 2017, arXiv:1711.05225.]. These models demonstrate the potential of using deep learning models in detecting pneumonia and other pathological diseases from chest X-rays by achieving performance levels that exceeded or matched those of practicing radiologists. Similar accuracy (81%) was shown by DeepCOVID-XR even when compared to the consensus of all five radiologists. Interestingly, DeepCOVID-XR demonstrated a notably greater specificity (92%) compared to two radiologists (75%, P<0.001; 84%, P=0.009) and a significantly higher sensitivity (71%) compared to a single radiologist (60%, P<0.001). However, with a P-value of 0.13 coupled with the difference between DeepCOVID-XR's AUC of 0.88 and the consensus AUC of 0.85 was not statistically significant [R. M. Wehbe et al., Radiology, vol. 299, no. 1, pp. E167-E176, April 2021.]. The disparity in performance throughout the training and testing phase has to be more persuasive to the radiologists, even though the performance was better than that of individual radiologists. Other studies have also found the CNN models to be on par with the assessment of the radiologist [I. Drozdov et al., Sci. Rep., vol. 11, no. 1, p. 20384, October 2021.]. Although the design and training of these models become more complex as additional classes of diseases for classification are introduced, they offer a promising glimpse into the potential for deploying CNNs to identify novel diseases in real time. To benefit from such an approach, we require a model that balances efficiency with accurate classification capability, ensuring it is lightweight enough for time-sensitive applications yet sufficiently robust enough to classify diseases accurately.

LIGHT-WEIGHT PREDICTION MODELS: One of the popular methods of training a CNN model is extracting knowledge from one domain and transferring it to another through transfer learning. Pre-training is one of the transfer learning strategies that has been frequently applied in CXR analysis. The pre-training strategy starts out with training the network architecture on a large dataset for a different task. The trained weights obtained from this phase are then utilized as an initialization for the subsequent jobs to fine-tune them. Either all layers or just the last layer may be retrained, depending on the dataset of the target domain. Because important low-level features are acquired from the source data, this method enables neural networks to be trained for new tasks using comparatively smaller datasets. For the purpose of classifying real images, pre-training on the ImageNet dataset has been demonstrated to be advantageous [I. M. Baltruschat et al., Sci. Rep., vol. 9, no. 1, p. 6381, April 2019.]. Additionally, pre-trained architectures can be used for feature extraction in conjunction with more conventional techniques like random forests or support vector machines. Moreover, there have been many comprehensive studies about using lightweight convolutional neural networks (CNNs) to detect diseases using chest X-rays. Lightweight models from the SqueezeNet, VGG, and MobileNet model families have been determined to classify multiple classes of diseases with minor tweaks to their architectures [I. D. Apostolopoulos and T. A. Mpesiana, Phys. Eng. Sci. Med., vol. 43, no. 2, pp. 635-640, June 2020.].

DATA ACQUISITION DIVERSITY: In most previous research, researchers have trained their supervised deep neural networks (DNN) on a large pool of labeled data. However, in medical imaging, labeled data is scarce due to privacy concerns, and the manual annotation by professional radiologists and physicians requires tedious, time-consuming effort. Although some large labeled datasets are available, they can be severely imbalanced by overrepresenting common problems and under-representing rare conditions. Moreover, the resolution of differential diagnosis in these diseases is generally low, so the fine detection and classification for diagnosis among images is not feasible. This imbalance can lead to poor performance of DNNs on rare diseases. As expected, there are several datasets that have gathered ChestX-ray pictures of various health conditions, including MIMIC-CXR, BIMCV, COVIDDSL, and COVIDGR, consisting of images of various resolutions and quantities. The National Institutes of Health (USA) gathered 112,120 pictures of 30,805 patients to create ChestX-ray14 [S. Tabik et al., IEEE J. Biomed. Health Informat., vol. 24, no. 12, pp. 3595-3605, December 2020.]. The images are grayscale 1024×1024 pixels with 8-bit labels from radiological reports that show 14 different disease kinds. The MIMIC-CXR dataset comprises 371,920 pictures gathered from 64,588 patients [A. E. W. Johnson et al., Sci. Data, vol. 6, no. 1, p. 317, December 2019.] who were admitted to Beth Israel Deaconess Medical Center's emergency department between 2011 and 2016. This dataset was likewise labeled from radiology records using the same rule-based labeler method as CheXpert. Chest X-rays and CT scans are included in the BIMCV COVID-19 dataset, provided by the Valencian Region Medical ImageBank in 2020 [M. de la I. Vayá et al., 2020, arXiv:2006.01174.]. The dataset includes 3293 16-bit original resolution images from 1305 COVID-19 patients. The HM Hospitales group in Spain released the COVID-19 dataset known as COVIDDSL [X. P. Burgos-Artizzu, medRxiv, July 2020.]. It contains comprehensive laboratory test results, vital signs, and CXR images for 1725 individuals. Confirmed COVID-19-positive status is reported for every individual. By related RT-PCR results acquired in less than 24 hours, half of the 852 PA CXR pictures in the COVIDGR dataset are classified as COVID-19 positive [S. Tabik et al., IEEE J. Biomed. Health Informat., vol. 24, no. 12, pp. 3595-3605, December 2020.]. The degree of severity of positive cases is shown in this dataset, which was gathered from Hospital Universitario Clinico San Cecilio in Granada, Spain.

Despite the availability of numerous public chest X-ray datasets, preparing the data for use with proposed models remains challenging due to issues with annotations, labeling consistency, and varying data formats. Most Datasets use Natural Language Processing (NLP) to generate labels for each image. Even though it is a fast and inexpensive labeling method, it results in inaccuracies in labeling [J. Irvin et al., 2019, arXiv:1901.07031.], [X. Liu et al., Lancet Digit. Health, vol. 2, no. 10, pp. e537-e548, September 2020.]. There might be several causes for such inaccuracies, as some visible abnormalities may not be mentioned in the radiology report, depending on the context in which it was acquired. The NLP algorithm can be erroneous, interpreting some negative statements as positive, failing to identify acronyms, and many more. Furthermore, many findings on CXR are subtle or doubtful, leading to disagreements even among expert observers [T. Olatunji et al., 2019, arXiv:1905.02283.]. The CheXpert dataset mentions no labels or uncertain levels to account for this uncertainty. One particular cause for concern with NLP labels is the issue of systematic or structured mislabeling, where a disease is consistently mislabeled in the same way. This example occurs in the ChestX-ray14 dataset, where subcutaneous emphysema is frequently identified as pulmonary emphysema [E. Qalli et al., PLoS ONE, vol. 17, no. 7, July 2022, Art. no. e0267539.], [L. A. Smith et al., Lancet Digit. Health, vol. 5, no. 12, pp. e872-e881, December 2023.].

However, this fragmentation can be used advantageously. Since there are multiple specialized clinics for the treatment of specific diseases, the labeled data from the experts in these institutions can be retrieved to train the CNN models precisely to diagnose these diseases. Nonetheless, there needs to be more clarity between the current deep learning-based methods and the medical demands that require the detection of subtle differences like which stage or at what scale the disease has spread through the medical images. For example, pulmonary edema is a fluid buildup in the lungs and is one of the most direct symptoms of Chronic Heart Failure (CHF) [H. Mahdyoon et al., Amer. J. Cardiol., vol. 63, no. 9, pp. 625-627, March 1989.], where the heart cannot pump blood effectively. CHF patients have extremely heterogeneous responses to treatment [G. S. Francis et al., J. Amer. College Cardiol., vol. 64, no. 17, pp. 1775-1776, 2014.] and respond differently to the same medications and interventions. This makes it difficult for clinicians to come up with effective treatment plans. Assessing the severity of pulmonary edema will enable clinicians to make better treatment plans based on prior patient responses, where deep learning methods are instrumental. It will facilitate clinical research studies that require quantitative phenotyping of the patient's status [S. Chakko et al., The Amer. J. Med., vol. 90, no. 1, pp. 353-359, 1991.]. However, quantifying pulmonary edema is a highly challenging task. The grading of pulmonary edema severity relies on much more subtle image findings than detecting pathologies in chest X-ray images [P. Rajpurkar et al., 2017, arXiv:1711.05225.], [X. Wang et al., in Proc. IEEE Conf Comput. Vis. Pattern Recognit. (CVPR), Los Alamitos, CA, USA: IEEE Computer Society, July 2017, pp. 3462-3471.]. To fill the gap between the current deep learning-based methods and the medical demands of detecting subtle differences in medical images, disclosed herein is a distributed, scalable system that uses image processing and standardizing techniques to enable user-defined targets for specific specialty areas. Various models are effective in the classification of specific diseases but not others. Therefore, ensembling methods for combining the predictions of these models can help create a unifying solution for diagnosing these diseases.

ENSEMBLE LEARNING: Using ensemble learning, the benefits of several baseline models can be combined to build a better model than its constituents [A. Kumar et al., IEEE J. Biomed. Health Informat., vol. 21, no. 1, pp. 31-40, January 2017.] with the added benefit of reducing the probability of overfitting. This technique has been successfully applied to several fields, including character recognition [A. Ekbal and S. Saha, Expert Syst. Appl., vol. 38, no. 12, pp. 14760-14772, November 2011.] and sentiment analysis [J. Prusa et al., in Proc. IEEE Int. Conf. Inf. Reuse Integr., August 2015, pp. 252-257.]. Various ensembling strategies differ in how distinct baseline models are learned and blended. The most commonly utilized ensemble approaches are averaging, bagging, random forest, stacking, metalearning, and boosting [X. Dong et al., Frontiers Comput. Sci., vol. 14, pp. 241-258, April 2020.], [B. Krawczyk et al., Inf. Fusion, vol. 37, pp. 132-156, September 2017.], [O. Sagi and L. Rokach, WIREs Data Mining Knowl. Discovery, vol. 8, no. 4, p. e1249, July 2018.]. Nevertheless, most of these efforts apply average voting mechanism baseline deep-learning models. A majority voting classifier [Chandra et al., Expert Syst. Appl., vol. 165, March 2021, Art. no. 113909.] for detecting pneumonia and COVID-19 performed admirably in classifying these diseases. The transfer learning approach combined with ensembling gives satisfactory performance. However, as shown in the results section herein, combining baseline learners using maximum voting is only sometimes the best strategy, as the ensembling process using average voting techniques is skewed toward weak baseline learners. Another popular technique for ensembling is using stacking. In CovXNet [Mahmud et al., Comput. Biol. Med., vol. 122, July 2020, Art. no. 103869.] a meta-learner was used to stack the output of the models to give a respectable final prediction. However, the shallow neural network does not clearly show the bias of the neural network towards any specific individual classification model. Therefore, a more interpretable model was needed that can convince medical practitioners about these models' reliability and unbiased predictions. Pruning can help reduce the complexity and eliminate the bias [Rajaraman et al., IEEE Access, vol. 8, pp. 115041-115050, 2020.] in the disclosed ensembled model. However, pruning is computationally intensive and is not ideal for providing the results in a short time, voiding the objective of achieving large-scale diagnosis at a faster rate. Some other ensembling models, like DeepCOVID-XR [R. M. Wehbe et al., Radiology, vol. 299, no. 1, pp. E167-E176, April 2021.], have used the weighted averages of the individual models to get decent results. However, the weights assigned to each model are subjective, and there is no definitive way to arrive at the optimal solution on the Pareto boundary, as each point on this boundary gives us the same value for the objective function. It is also possible that one might end up with a biased model which is impractical for sensitive medical diagnosis applications. Although numerous approaches for merging baseline learners can be used for group deep learning, these approaches have certain drawbacks concerning generalization and training challenges.

The disclosed example presents an integrated system tailored to enhance diagnostic processes for respiratory diseases through detailed analysis of chest X-rays at the edge. The system's architecture is designed to balance robustness with efficiency. The main aspects of the system and method can be summarized as follows: Multiple light-weight prediction models are specifically optimized to differentiate between various respiratory conditions by examining the distinct features within the images. Notably, the disclosed system architecture permits the separation of various far-edge, near-edge, and on-premises predictive components, thereby enhancing flexibility and allowing for extensive feature extraction and model training without the constraints of immediate output. Disclosed is an innovative ensembling strategy incorporating meta-learning and deftly consolidating the predictive outputs. The flexibility of the disclosed architecture shines in this component, enabling real-time ensemble learning to provide prompt and request-oriented classification while preserving the integrity of the in-depth training previously conducted. This dual-structure ensembling is instrumental in delivering swift and precise final diagnoses. The disclosed methodology deliberately utilizes a limited but representative subset of images for each disease class, reflecting the realistic scenarios of data limitation typically encountered during novel disease emergence at a specialty center. The classification models serve as the backbone for disease identification through a decision tree for ensembling and ascertaining definitive disease classifications. The distinctive separation of the disclosed system's prediction and ensembling components fosters a flexible, decentralized, and scalable architecture. This architecture balances the need for rapid and rigorous feature extraction training with the demand for efficient classification on demand.

### System Design and Methodology, System Architecture

In FIG. 1, the system diagram of the disclosed solution is described. In some embodiments, several chest X-rays are collected regularly, which the specialists label according to the patient's medical condition at the hospitals. These labeled CXR images are then processed on-premises and/or are sent to the edge servers, where these images may be processed according to the process described in FIG. 3. If a new class of disease is detected that is not in the disclosed system's database, notification alerts may be sent to all the physicians in the network about a potential outbreak of a novel disease so that they may take preventive measures to contain the spread of the disease. Furthermore, multiple neural networks may be trained at the edge servers to classify new diseases, which may be stored securely on a cloud server that hosts the patients' medical records. Sensitive personal information can be encrypted and obfuscated to preserve the privacy and confidentiality of the information stored on the servers. This process may happen in the background as a part of the scheduled batch processes. Suppose a particular clinic, lab, or physician needs access to these models. Depending on their needs, individual models or ensembled models may be provided, which employ a lightweight meta-learning approach and can be used on mobile devices to categorize diseases based on available CXR images. This acts as getting a second opinion from experts. In some embodiments, the meta-learning model are periodically fetched from the distributed devices to keep the local model in sync with the latest model(s) available on the servers. Disclosed herein is an overview of how to process the CXRs generated at the hospital and use machine learning models to assist the physicians in diagnosing the patients' health conditions. The details about the crucial components of the system architecture are described herein: Distributed Learning: Several sites are used, which can be specialty centers for diseases or research labs, working on detecting several respiratory diseases. Each site maintains its own database of anonymized chest X-rays, which will be synced with a decentralized database, with provisions for redundancy, in the cloud. Anyone authorized to put the images on these servers will specify the label associated with the diagnosis of the image and will store the individual's digital signature along with the image for future audits. Training Servers: Several commodity hardware are used that will serve as the distributed training servers and will run multiple models and use several metrics as their benchmark to choose the best model for classifying the disease. Using the image data gathered from the patients, these models will be hosted on distributed servers with restricted access to prevent unauthorized access and manipulation. The physicians will play a critical role in feature extraction, model selection, and optimization processes by training on the server to create the model. Ensemble System: This component combines the results from all sites and can use several approaches, such as voting, stacking, meta-learning, etc, to aggregate predictions from multiple models and reduce computational cost. HCI Interaction System: The “ENSEMBLE” model can run locally on the handheld device to get the final prediction, or can get the predictions from one of the edge servers. This approach allows for diverse real-time consultation and can mitigate biases inherent to individual models and radiologists using knowledge from different parts of the world.

FIG. 1 is a diagram depicting an exemplary Collaborative Ensembling Architecture employed by the disclosed system and method. After preprocessing of CXR images at the edge, these images are analyzed using a local ensembling model that combines predictions from multiple models. These models are periodically synchronized with the latest meta-learning models from the cloud to keep them fresh. Physicians can interactively transmit CXR images and obtain disease classification results through this local model, facilitating rapid diagnosis in clinical communication (HCI Communication). When an unknown disease is detected, images are sent to the cloud for further analysis and new modeling, ensuring the system adapts to emerging health risks.

### Dataset Description

As seen in Table 1, the MIMIC-CXR and COVIDGR datasets have images with several resolutions, which might throw off the classification models during training. Therefore, the standardization of the image resolutions was required to mitigate the effects of the image sizes and pixel counts on the disclosed models. Subsequently, integrating a standard range of pixels can make the dataset of images widely accessible to researchers who will require minimal preprocessing in terms of standardization and improve collaborative research. 595 COVID-19, 618 Viral Pneumonia, and 625 images were randomly sampled for Normal cases. The images were resized to 256×256 pixels. Furthermore, these pixels were normalized to a value between 0-1 for more efficient training of the neural networks. While CNN-based models anticipate a 3-channel picture, radiography images are usually 1-channel images. In order to prepare the single-channel photos for use with models intended for three-channel RGB inputs, the grey-scale information was replicated in each image channel.

TABLE 1
Resolution of images in the dataset.

| | |
|---|---|
| Width | Height |

| Image Class | Min | Max | Min | Max |
|---|---|---|---|---|
| Normal | 1040 | 2628 | 650 | 2628 |
| COVID-19 | 240 | 3520 | 237 | 4095 |
| Viral | 384 | 2304 | 127 | 230 |

IMAGE PREPROCESSING: X-rays pass through an object and interact with the photographic emulsion on a film to create a radiographic image [Ahmad et al., Proc. IEEE EMBS Conf Biomed. Eng. Sci. (IECBES), November 2010, pp. 400-405.]. The chemicals in the capturing film react with the X-rays and turn dark. The discoloration depends upon the amount of X-rays hitting the film, which depends on the object's density. So, these images have superimposed black, white, and grey shadows. The perceived density of the adjacent structures may change depending on their contrast [Whaites and Drage, Essentials of Dental Radiography and Radiology, Elsevier, 2013.]. Therefore, complex processing is required to reach the diagnosis from these images. Several studies have been conducted on enhancing the images to improve their clarity [Ningsih, Int. J. Image, Graph. Signal Process., vol. 12, no. 2, pp. 30-41, April 2020.]. The approach described in the flowchart shown in FIG. 3 was utilized, and is discussed herein.

FIG. 3 is a flowchart showing the step-by-step process of an exemplary image enhancement process of the disclosed system and method. Starting with the grayscale conversion of input images, contrast-limited adaptive histogram equalization (CLAHE) is applied and then the images further refined using a median filter, resulting in the final output image.

GRAYSCALE CONVERSION: The images obtained from various sources might have more than one-channel of color. Therefore, they were converted into grayscale to better control the training dataset. This can be done using the formula [Acharjya et al., Int. J. Adv. Res. Comput. Sci. Softw. Eng., vol. 4, no. 1, pp. 552-557, 2014.] below:

$$Grayscale = ( 0.299 \times R ) + ( 0.587 \times G ) + ( 0.114 \times B ) \qquad Equation 1$$

where, R=red channel matrix value, G=green channel matrix value, and B=blue channel matrix value

CONTRAST STRETCHING: This technique stretches the contrast by expanding the dynamic range of the image's intensity value. Using linear scaling to apply the image's pixel value is possible. Finding the image's minimum and maximum values is required in order to normalize or contrast-extend the image. The image boundary is defined by these minimum and maximum values. The lowest limit of this suggested method is an image with an 8-bit gray level, while the image density has a minimum value of 0 and a maximum value of 255. The equation is given by:

$$g ( x , y ) = \frac{f ( x , y ) - min \}}{max - min \}} * 255 \qquad Equation 2$$

where, ⋅ g(x, y)=matrix of the resulting image ⋅ f (x, y)=original image matrix value.

FIG. 7A & FIG. 7B are chest X-ray images of COVID-19 in a subject before and after applying CLAHE.

HISTOGRAM EQUALIZATION: Histogram equalization (HE) is widely used to flatten the gray distribution of images by adjusting the values of corresponding image pixels to yield higher contrast. The flattened histogram distribution function is then applied to the image. The output of the process gives the intensity and scale for the pixel value at the gray level. The goal of this HE was to create an evenly distributed histogram where input images with different intensity levels produce output images with the same contrast level [Rahim et al., Proc. IEEE 10th Int. Colloq. Signal Process. Appl., March 2014, pp. 221-224.] at a global level. Adaptive histogram equalization (AHE) may be used as a popular method to enhance the contrast of images. Using several histograms, the image's luminance is calculated for different sections of the image, which results in better edge visualization and increased local contrast. However, the noise might be amplified in homogeneous regions. This can be prevented by using contrast-limited adaptive histogram equalization (CLAHE) [Zuiderveld, Graphics Gems IV, Academic, 1994, pp. 474-485.], [Ma et al., Int. J. Pattern Recognit. Artif. Intell., vol. 32, no. 7, 2018, Art. no. 1854018.] for local contrast enhancement.

The advancement of HE and AHE into CLAHE, a contrast enhancement technique, makes CLAHE a superior alternative to HE and AHE. Because CLAHE restricts contrast to local blocks, it uses the maximum value on the local grids to clip and return the gray values. Images in CLAHE are split into tiles for better manageable regional sections, which prevents noisy images. The equation below describes the computation of CLAHE,

$$p = ( {p}_{max} - {p}_{min} ) \cdot P ( f ) + {p}_{min} \qquad Equation 3$$

where the new pixel value p is obtained by applying a formula using the maximum and minimum pixel values of the image pₘₐₓ and pₘᵢₙ and the cumulative probability distribution function P(f). In other words, the new pixel value was computed by scaling the cumulative probability distribution function to the range between pₘₐₓ and pₘᵢₙ, and then adding pₘᵢₙ to the result. FIG. 7 compares the effects of applying CLAHE on the original image.

MEDIAN FILTER: To preserve image information, noise in the image can be filtered or reduced using a non-linear technique called median filtering. Using values as medians will change or replace values on images. The gray level replaces the value with the median, which is subsequently stored in place of the noise value. Suppose the highest is given by the max and the minimum is given by the min, and then the average represents the gray level. Additionally, the median filter's manipulation center, y[m, n][Khan et al., PLoS ONE, vol. 13, no. 2, February 2018, Art. no. e0192203.], is given as:

$$y [ m , n ] = median \{ x [ i , j ] , ( i , j ) ∈ ω \} \qquad Equation 4$$

where, y[m, n]=matrix of results labeled as y with m, n as a rows and columns, and {x[i, j], (i, j)∈ω}=matrix value of the image being processed or the corresponding elements sorted.

Once the neighboring pixel value is determined, the median filter compares the current value to the value of the neighboring pixel values. At the intermediate value, the pixel value may be changed based on the count of neighboring pixels. An average of two middle values determines the median value [Reza, J. VLSI Signal Process.-Syst. Signal, Image, Video Technol., vol. 38, no. 1, pp. 35-44, August 2004.].

IMAGE AUGMENTATION: Data augmentation significantly expands the variety of the existing data sets without adding new data. Techniques such as cropping, padding, and horizontal flipping are commonly used to train large neural networks. It can improve accuracy and model training by creating multiple copies of the same image from different methods, such as rotation, rotation, sharpening, and many other methods. In previous studies [Ju et al., Inf. Sci., vol. 611, pp. 225-242, 2022.], the authors have used a deep convolutional neural network (CNN) trained on the CIFAR-10 dataset to perform geometric transformations. The accuracy of the CNN was 91.8%, which is much higher than the 89.6% accuracy obtained without geometrically implemented transformation.

As can be seen from previous studies, geometric transformation improves the performance of the image classification model by introducing more diversity in the training process and enabling the model to cope with changes in the orientation, shape, and location of segmented objects. Which in turn significantly improves the performance of image classification models. By providing more diversity in the training set, the geometric variations contribute to the model having more complex features that are less sensitive to the direction of changes in distributed features, size, and location, thus improving the accuracy and generalizability of unobserved test data. FIG. 8, shows the effects of applying image augmentation on a sample of images that would be used to train the model.

FIG. 8 is an exemplary set of 21 augmented X-Ray images for machine learning training. These augmented images, which include rotation, scaling, flipping, and cropping, improve the robustness of machine-learning models during training.

### Ensembling on Selected Lightweight Prediction Models

Following a comparative analysis of various lightweight prediction models in the background research, MobileNetV2 and SqueezeNet was selected for the disclosed framework because of the fewer parameters to train and their wider classification capabilities. MobileNetV2 stands out for its exceptional efficiency and accuracy in mobile and embedded vision applications, benefiting from a streamlined architecture that minimizes computational requirements while maintaining high performance [Howard et al., 2017, arXiv:1704.04861.]. SqueezeNet offers remarkable model compactness through the use of squeeze and expansion layers, achieving AlexNet-level accuracy with a fraction of the parameters, making it highly suitable for environments with strict memory limitations [Iandola et al., 2016, arXiv:1602.07360.]. The disclosed ensembling [Chaves et al., Domain Adaptation and Representation Transfer: 5th MICCAI Workshop, DART 2023, Springer, 2024, pp. 105-114.], [Hassan et al., 2018, arXiv:1812.00479.] framework can also be applied to other predictive models, enhancing its versatility and applicability across different domains. The architecture of MobileNetV2 and SqueezeNet with bypass are shown in FIG. 4A and FIG. 4B, respectively that would be a good fit for the type of problems the disclosed system and method solve. However, the data to train these models are sourced from several datasets. Hence, it becomes imperative to preprocess the data before training the models.

FIG. 4A & FIG. 4B are exemplary architecture diagrams for SqueezeNet (FIG. 4A) and MobileNetV2 (FIG. 4B) models.

An aggregation function A combines the results of n baseline classifiers c₁, c₂, . . . , cₙ to predict the final output. Suppose a dataset of size a and features of dimension b,

$$D = \{ ( {x}_{i} , {y}_{i} ) \} \frac{a}{i = 1} ,$$

where 1≤i≤a and xᵢ∈R^{b}. The prediction of the output based on this ensemble method is given by the equation below:

$${y}_{i} = Ω ( {x}_{i} ) = A ( {c}_{1} , {c}_{2} , … , {c}_{n} ) . \qquad Equation 5$$

Average voting [Kim et al., J. Korean Stat. Soc., vol. 40, no. 4, pp. 437-449, December 2011.] and meta-learning [Cruz et al., Pattern Recognit., vol. 48, no. 5, pp. 1925-1935, May 2015.], two popular ensemble learning techniques were used in this example. The concept behind average voting is that predictions are taken from several models, and the final prediction is determined by averaging these predictions [Montgomery et al., Political Anal., vol. 20, no. 3, pp. 271-291, 2012.]. As the function of the equation below illustrates, the arithmetic mean—the sum of the forecasts divided by the total number of guesses—was used to get the average prediction.

$${y}^{*} = arg max ( \frac{1}{{n}_{j}} {\sum }_{j = 1}^{m} {w}_{i , j} ) \qquad Equation 6$$

Consider a scenario in which the ensemble consisted of the following three classifiers: c₁(x)=[0.63, 0.17, 0.20], c₂(x)=[0.28, 0.51, 0.21], and c₃(x)=[0.61, 0.29, 0.10]. Using the average weight approach, the following would be the mean prediction y₀=[0.63, 0.28, 0.61]/3=0.506 for class 0 and a prediction of y₁=[0.29+0.17+0.51]/3=0.323 for the class 1 and y₂=[0.20+0.21+0.10]/3=0.17 for class 2.

The other ensemble learning method is learning from learners, popularly known as meta-learning [Cruz et al., Pattern Recognit., vol. 48, no. 5, pp. 1925-1935, May 2015.], [Soares et al., Mach. Learn., vol. 54, no. 3, pp. 195-209, March 2004.], which depends on prior experience with previous classification models. By altering some parts of the learning algorithm in response to experimental findings, performance and outcomes can be enhanced. In contrast to conventional machine-learning models, the meta-learning approach uses multiple learning stages, with each stage inducing its output as an input to the meta-learner, which produces the final output [Kuruvayil and Palaniswamy, J. King Saud Univ. Comput. Inf. Sci., vol. 34, no. 9, pp. 7271-7282, October 2022.]. Moreover, meta-learning helps learning algorithms better adapt to changing circumstances, expedites learning processes by lowering the number of tests needed, and optimizes hyperparameters to provide ideal outcomes. Additionally, this approach offers the chance to address several deep learning challenges, such as generalization, computational complexity, and data size [Mohammed and Kora, J. King Saud Univ. Comput. Inf. Sci., vol. 35, no. 2, pp. 757-774, February 2023.]. An exemplary approach is detailed in the flowchart in FIG. 5, where individual model predictions are started with, followed by stacking, and then converting the target labels to a 1-D array. The meta-learning model is then trained and evaluated on the validation dataset, which yields the final output.

FIG. 5 is a Meta-learning model flowchart illustrating an exemplary step-by-step process starting with individual model predictions, stacking these predictions, and converting the target labels to a 1-D array. The meta-learning model is then trained and evaluated on the validation dataset, resulting in the final output.

### Experimental Setup

The TensorFlow library was used to build the disclosed neural networks. For the disclosed example, a Windows server 2022 machine was used functioning as the far-edge system and operating on an Intel Core i9-12900K processor with 64 GB DDR-4RAM and Nvidia RTX 3060 with 12 GB v-RAM. The hardware configuration for the low-power near-edge device was that of a Raspberry Pi 5 with 8 GB system memory. It had a Rasberry Pi OS installed on a Quad-Core ARM Cortex A76 processor clocked at 2.4 GHz and a Videocore-VII GPU clocked at 800 MHz. The model was also run on an x64 Intel NUC running Ubuntu 18.04 LTS server with a Core-i5 7260U quad-core processor clocked at 2.2 GHz with Intel Iris® plus graphics 640 and 16 GB of system memory that acted as the on-premises device. The training of the individual models for each disease was performed at the far-edge server, and finally, the ensembling of these models was performed at the far-edge, near-edge, and on the on-premises machines for comparison. The Intel NUC provided a balanced perspective, considering both mobility and computational power. Meanwhile, the Raspberry Pi 5 represented a SWaP (Size, Weight, and Power) constrained mobile device, highlighting the practical aspects of deploying edge computing in resource-limited environments. A 5-fold cross-validation was also used while training the model using a batch size of 32. A learning rate of 0.001 was started with and ran the models until 50 epochs with the Adam optimizer using 80% of the data for training and the remaining 20% for validation. Some sample images from each class of diseases are shown in FIG. 9. The distribution of images in the training and test sets is shown in Table 2.

TABLE 2
Distribution of images in the training and test sets.

Dataset

| Image Class | Training Set | Validation Set |
|---|---|---|
| Normal | 500 | 125 |
| COVID-19 | 476 | 119 |
| Viral Pneumonia | 494 | 124 |
| Total | 1470 | 368 |

The images were further processed using the steps detailed in FIG. 3. Furthermore, image augmentation was used to avoid overfitting (overfitting occurs when a model learns the training data too well and cannot generalize to new data). Image augmentation artificially increases the size of the training dataset by creating new images from existing images. This helps the model learn more about the underlying patterns in the data and generalize new data better. The augmented images are shown in FIG. 8. A Comparative analysis of the SqueezeNet and MobileNetV2 models for prediction on all 3 classes is shown in Table 3.

TABLE 3
Comparison of SqueezeNet and MobileNetV2
models for prediction on all 3 classes

| Model | SqueezeNet | MobileNetV2 |
|---|---|---|
| Accuracy | 0.9478 | 0.9753 |
| Precision | 0.9487 | 0.9752 |
| Recall | 0.9478 | 0.9753 |
| F1 Score | 0.948 | 0.9752 |
| AUC | 0.9949 | 0.9982 |
| Time | 38 m 22 s | 48 m 25 s |

As a baseline, the MobileNetV2 and SqueezeNet models were trained on all three classes, and for the evaluation of the performance of our method, a train-cross-validation-test approach was used. The selection of models was highly dependent on these use cases. Specifically, the choice of MobileNetV2 and SqueezeNet was driven by their suitability for resource-constrained environments at the edge and on-premises. These models have fewer parameters, leading to faster training times and smaller model sizes, which are essential for efficient distribution and collaborative resource integration. Further, the fewer parameters in MobileNetV2 and SqueezeNet not only accelerate the training process but also ensure that the models can fit into the memory of devices with limited resources. This enables more flexibility for deployment in environments where computational efficiency and model size are critical factors. The training set was used to train the deep CNN model, the 5-fold cross-validation set was used to fine-tune the model's hyperparameters, and the test set was used to assess the proposed method's effectiveness. The deep CNN model was trained with a minibatch size of 32. The Adam optimizer with weight decay was used, which is a technique that helps to prevent the model from overfitting. The initial learning rate was set to 0.001, and the maximum number of epochs to train the network was 50.

### Results and Discussion

Chest X-rays are the most common type of diagnosis tool for respiratory diseases, with over 2 billion in medical examinations per year. Nonetheless, there is a scarcity of radiology experts who can interpret these images. A significant benefit of developing machine learning models for respiratory disease diagnosis is the possibility of capturing and disseminating some aspects of expert knowledge from the labeling of the images used for training the models. These models are trained on large datasets that include annotations by experienced diagnosticians that could assist physicians all over the world by providing additional insights or second opinions during the diagnostic process. As shown in FIG. 10, SqueezeNet and MobileNet-V2 are the two models that have one of the least amount of trainable parameters and, hence, the simpler models for training them on the dataset. In Table 3, the results of the training process for all three classes using the CNN models identified earlier, namely MobileNetV2 and Squeezenet, are reported. These models provide excellent results in classification, as can be seen from the accuracy and loss curves in FIG. 11. However, they require a significant amount of resources in terms of computation and time for training, as described in Table 3, which does not provide real-time classification of diseases. Additionally, more complex models are needed when more classes of diseases are added to the training dataset. Since no model is perfect for the classification of all classes of diseases, multiple models may be tried to get the best possible performance. To reduce the time and resources spent on training, the models were trained on individual diseases, and later, using the predictions from these smaller models, the predictions were inferred about the conditions of the patients using ensemble learning. These smaller models, trained for the classification of individual diseases, serve as the seed models for the disclosed ensemble models. They provide better results for the classification of a couple of classes of diseases, as shown in FIG. 12. This observation is corroborated in the complete performance metric shown in Table 4. Shown is almost perfect predictions for both of these diseases; however, the training time is still quite a significant bottleneck. The confusion matrix for each approach is shown in FIG. 14 to provide more clarity about the classification performance of the two seed models. As shown in the confusion matrix, the two models perform commendably in classifying the diseases. Therefore, these two models were used to make predictions using several ensemble learning approaches like average voting (Avg. Voting) and meta-learning approach using logistic (ML-LR) regression and decision trees (ML-DT), respectively.

FIG. 9A, FIG. 9B, and FIG. 9C are a compilation of three sets of chest X-ray images for different health issues. The first set (FIG. 9A) represents the X-rays of patients suffering from COVID-19. The second set (FIG. 9B) represents the X-rays of patients suffering from viral pneumonia. The last set (FIG. 9C) includes X-rays of healthy individuals without any sickness.

FIG. 10 is a plot showing the number of trainable parameters in each model used for ensembling in the literature.

A comparative analysis of the models for individual disease detection (Squeezenet for COVID-19 detection and Mobilenetv2 for Pneumonia detection) is shown in Table 4.

TABLE 4
Comparative analysis of the models for individual disease detection

| Model | Squeezenet | Mobilenetv2 |
|---|---|---|
| Accuracy | 1 | 0.97 |
| Precision | 1 | 0.9758 |
| Recall | 1 | 0.968 |
| F1 Score | 1 | 0.9719 |
| AUC | 1 | 0.9932 |
| Time | 32 m 28 s | 39 m 17 s |

FIG. 11A & FIG. 11B are plots showing a performance evaluation for the baseline models classifying COVID-19 and pneumonia using the accuracy and loss plots during the training and validation phases.

FIG. 12A & FIG. 12B are plots showing a performance evaluation of disease classification models for binary classification of the respiratory diseases using the accuracy and loss plots during training and validation phase using the seed models for ensemble learning.

As can be seen from Table 5, the average voting ensemble approach performs poorly when compared to the baseline models. This can be explained by the potential overfitting of the dataset, which results in subpar performance during validation. However, in contrast, meta-learning using the logistic regression (ML-LR) model results in performance that is in line with the SqueezeNet model for predicting the output for the three classes of diseases. Moreover, the results were within 5% of the MobileNetV2 model. Nonetheless, when a decision tree (ML-DT) classifier was employed, better and more explainable results were achieved, as shown in FIGS. 13A, 13B & 13C. This provides a balance between the training and inference time as well as the critical metrics for evaluating the models. From the root node of the decision tree in FIGS. 13A, 13B & 13C, it is shown where the initial decision has been made after stacking the individual predictions column-wise. This aligns with the observations in Table 5. With a minimal overhead of (28 ms), a perfect score in all of the crucial metrics was reached. With accuracy, sensitivity, specificity, F1-score, and AUC of 97.80%, 97.06%, 98.48%, 96.51%, and 0.9739 respectively, commendable diagnostic performance was achieved. The ensemble model surpasses the sensitivity of only 60%-70% shown by the RT-PCR tests with a sensitivity of 96.48%. Additionally, manual intervention to set up the weight of the individual classification models was not needed, and predictions based on the probabilities generated by the individual classification models can be made. These smaller and lightweight models can effectively capture the details from the X-rays, thereby circumventing the high cost associated with manual labeling and hyperparameter tuning. Moreover, they can be trained independently over several geolocations and ensembled on-demand to preserve the privacy of the patients by on-site training of the models. This reduces the time required to anonymize the images for the training process and avoids the labeling errors introduced by the traditional NLP-based annotation systems used by the EHR software solutions. Therefore, it is a model of choice for deploying on the edge and on-premises servers.

FIGS. 13A & 13B is a diagram depicting an exemplary decision tree of the ensembling model used for image classification in the disclosed system and method, where the tree is color-coded to represent different classes of images: orange nodes correspond to the first class, green nodes to the second class, and purple nodes to the third class, and each node in the tree represents a decision point, depicting the path taken depending on the outcome of the decision.

FIG. 13C is a diagram depicting an exemplary decision tree of the ensembling model used for image classification in the disclosed system and method. The tree is patterned to represent different classes of images: dotted nodes correspond to the first class, diagonal line nodes to the second class, and zig zag nodes to the third class. Each node in the tree represents a decision point, depicting the path taken depending on the outcome of the decision.

FIG. 14 is a set of matrices showing a comparative performance of various machine learning models in classifying Pneumonia and COVID-19, as depicted by the confusion matrices. Each matrix provides a detailed breakdown of true positives, true negatives, false positives, and false negatives, offering a comprehensive view of each model's predictive accuracy and error rate. The models are categorized into three groups: (a, b) Seed models (MobileNetV2 and SqueezeNet) trained on individual disease tasks to generate probability matrices for ensemble learning; (c) Maximum voting ensemble method combining predictions from seed models; (d) Meta-learning approach leveraging seed model outputs for joint disease classification. (e, f) Baseline models (MobileNetV2 and SqueezeNet) trained for simultaneous pneumonia and COVID-19 prediction. The meta-learning model (d) and standalone MobileNetV2 (e) emerge as the top-performing techniques, accurately classifying most cases across all disease classes. A comparative analysis of the three ensemble models is shown in Table 5.

TABLE 5
Comparative analysis of the three ensemble models

| Model | Avg. Voting | ML-LR | ML-DT |
|---|---|---|---|
| Accuracy | 0.8379 | 0.9368 | 0.978 |
| Precision | 0.8859 | 0.944 | 0.9706 |
| Recall | 0.8379 | 0.9368 | 0.9848 |
| F1 Score | 0.8228 | 0.9369 | 0.9651 |
| AUC | 0.991 | 0.9902 | 0.9739 |
| Time | 7 ms | 151 ms | 28 ms |

In a resource-constrained environment such as hospitals that are being flooded with patients infected by novel diseases such as COVID-19, there is always a trade-off between the time required for an accurate prediction and the accuracy of prediction. Having trained the disclosed model on 1470 training images and testing the effectiveness of the model on 368 images, there is high confidence in its effectiveness. To further substantiate the claims, the disclosed approach has been compared with the previous studies described in the literature survey section, as shown in Table 6 and Table 7. The disclosed model performs well across all performance metrics, unlike the other models, where greater performance on one metric was observed while compromising on others during evaluation. Moreover, the models used by the other studies have substantially more trainable parameters than the models used in the disclosed example. This can be confirmed by FIG. 10. Since these models perform binary classification, using a more complex model doesn't make sense, especially when identical performance can be achieved from smaller, lighter, and more efficient models. Furthermore, the additional complexity will result in longer training times, transmission delay, and larger memory needs during ensembling, which may be difficult to achieve on on-premises devices with less system memory. As the final models were lightweight compared to the models used by other researchers, the potential to run the ensembling process on low-power devices that one would typically find with the end users was explored. The experiments were run on lower-powered devices that usually act as portable mobile personal computers, near-edge, and far-edge devices, like a low-powered x86 PC, an ARM device, and a desktop equipped with a dedicated GPU, to confirm the assertion made earlier. The resource utilization on these devices was measured as shown in Table 8. The lowest resource utilization and latency were observed on the commodity hardware desktop functioning as the far-edge server, which was used to train the CNN models earlier. This is representative of the performance expected from a far-edge device. Surprisingly, the Raspberry Pi 5, functioning as a near-edge device, performed much better than the Intel NUC in carrying out the task because of its higher clock speeds. The meta-learning model was able to be run and got modest performance in terms of computation time and other system metrics on a low-power ARM device, which justifies the deployment of the disclosed architecture for practical applications. The observations from Table 9 support these claims. Multiple samples can be run in a second, which assured that these machines can keep up with the higher demands for diagnosis in real-life scenarios. Assuming that there's an average home internet connection of 300 Mbps at the diagnostic lab, which is a reasonable assumption to make in developing nations, a network latency of about 15.1 milliseconds existed for getting the results from the far-edge server, and an additional 15.76 milliseconds for processing. Even with this additional overhead for the network latency, a maximum throughput and minimum latency per sample was achieved for the near-edge server. The Intel NUC performed the worst, while the Raspberry Pi 5 sits in between. Thus, it was concluded that by using the near-edge and far-edge devices, low-latency predictions were achieved. However, if there is a concern about the privacy of the patient, one can opt for the on-premises solution.

TABLE 6
Comparison to previous studies

| | Sensi- | Speci- | Accu- | F1- |
|---|---|---|---|---|
| Model | tivity | ficity | racy | Score |
| CheXNeXt [P. Rajpurkar et al., | 72.30% | 67.40% | — | 75% |
| 2017, arXiv: 1711.05225.] | | | | |
| Apostolopoulos and Mpesiana [I. | 92.85% | 98.75% | 93.48% | — |
| D. Apostolopoulos and T. A. | | | | |
| Mpesiana, Phys. Eng. Sci. Med., | | | | |
| vol. 43, no. 2, pp. 635-640, June | | | | |
| 2020.] | | | | |
| Majority voting classifier | 91.33% | 86.21% | 87.37% | 96.51% |
| [Chandra et al., Expert Syst. Appl., | | | | |
| vol. 165, March 2021, Art. no. | | | | |
| 113909.] | | | | |
| CovXNet [Mahmud et al., | 95.63% | 91.25% | 95.62% | 91.21% |
| Comput. Biol. Med., vol. 122, July | | | | |
| 2020, Art. no. 103869.] | | | | |
| Iteratively Pruned Deep | 97.82% | 97.86% | 97.82% | 97.82% |
| Ensembling [Rajaraman et al., | | | | |
| IEEE Access, vol. 8, pp. | | | | |
| 115041-115050, 2020.] | | | | |
| DeepCOVID-XR [R. M. Wehbe et | 71% | 92% | 82% | — |
| al., Radiology, vol. 299, no. 1, pp. | | | | |
| E167-E176, April 2021.] | | | | |
| RAIDER | 97.06% | 98.48% | 97.80% | 96.51% |

TABLE 7
Comparison to previous studies

| | | Model | | |
|---|---|---|---|---|
| Model | AUC | Parameters | Dataset | Year |
| CheXNeXt [P. Rajpurkar | 0.862 | 69,682,060 | NIH ChestX-ray14 set [Wang et | 2018 |
| et al., 2017, | | | al., Proc. IEEE Conf. Comput. | |
| arXiv: 1711.05225.] | | | Vis. Pattern Recognit. (CVPR), | |
| | | | July 2017, pp. 2097-2106] | |
| Apostolopoulos and | — | 167,519,029 | COVID-19 image data collection | 2020 |
| Mpesiana [I. D. | | | [Cohen et al., 2020, | |
| Apostolopoulos and T. A. | | | arXiv: 2003.11597.] and CXR | |
| Mpesiana, Phys. Eng. Sci. | | | images [Kermany et al., Mendeley | |
| Med., vol. 43, no. 2, pp. | | | Data, vol. 2, no. 2, p. 651, 2018.] | |
| 635-640, June 2020.] | | | | |
| Majority voting classifier | 0.914 | — | COVID-Chestxray set [Cohen et | 2020 |
| [Chandra et al., Expert | | | al., 2020, arXiv: 2003.11597.], | |
| Syst. Appl., vol. 165, March | | | Montgomery set [Jaeger et al., | |
| 2021, Art. no. 113909.] | | | IEEE Trans. Med. Imag., vol. 33, | |
| | | | no. 2, pp. 233-245, February 2014.], | |
| | | | and NIH ChestX-ray14 set [Wang | |
| | | | et al., Proc. IEEE Conf. Comput. | |
| | | | Vis. Pattern Recognit. (CVPR), | |
| | | | July 2017, pp. 2097-2106.] | |
| CovXNet [Mahmud et al., | — | 446,072,632 | X-rays collected in Guangzhou | 2020 |
| Comput. Biol. Med., vol. | | | Medical Center [Kermany et al., | |
| 122, July 2020, Art. no. | | | Mendeley Data, vol. 2, no. 2, p. | |
| 103869.] | | | 651, 2018.] and Sylhet Medical | |
| | | | College COVID-19 dataset | |
| Iteratively Pruned Deep | 0.997 | 331,446,268 | X-rays collected in Guangzhou | 2020 |
| Ensembling [Rajaraman et | | | Medical Center [Kermany et al., | |
| al., IEEE Access, vol. 8, | | | Mendeley Data, vol. 2, no. 2, p. | |
| pp. 115041-115050, | | | 651, 2018.] and Sylhet Medical | |
| 2020.] | | | College COVID-19 dataset | |
| DeepCOVID-XR [R. M. | 0.9 | 145,512,785 | NIH ChestX-ray14 set [Wang et | 2021 |
| Wehbe et al., Radiology, | | | al., Proc. IEEE Conf. Comput. | |
| vol. 299, no. 1, pp. | | | Vis. Pattern Recognit. (CVPR), | |
| E167-E176, April 2021.] | | | July 2017, pp. 2097-2106] | |
| RAIDER | 0.974 | 24,272,882 | MIMIC-CXR and COVIDGR | 2024 |
| | | | dataset | |

TABLE 8
Resource utilization on various devices.

| | | Memory | | Time | |
|---|---|---|---|---|---|
| Machine | CPU | RAM | v-RAM | Train | Test |
| Near-Edge | 31 | 2.8 GB | 3.6 GB | 23 | 5 |
| Intel NUC | 84 | 3.4 GB | — | 297 sec | 49 sec |
| Raspberry Pi 5 | 98.10 | 4.38 GB | — | 153 sec | 37 sec |

TABLE 9
Performance on various devices.

| | Throughput (samples/sec) | | Latency per sample | |
|---|---|---|---|---|
| Machine | Train | Test | Train | Test |
| Near-Edge | 63.435 | 72.8 | 30.86 | 28.77 ms |
| Intel NUC | 4.9125 | 7.4286 | 204.3 | 134.6 ms |
| Raspberry Pi | 9.5359 | 9.8378 | 104.9 | 101.6 ms |

Finally, presented herein are the Grad-CAM images for different diseases in FIG. 16 and FIG. 15 for better interpretability of the models by the diagnosticians. The highlighted areas were identified as the most critical ones for making the classification. FIG. 17A through FIG. 17D shows several predictions made on the chest X-rays using this model with their respective truth labels and further justifies the balance RAIDER architecture has struck between training time and resource consumption.

FIG. 15A & FIG. 15B are images showing a comparative visualization pneumonia diagnosis. FIG. 15A depicts an unprocessed X-ray of a lung belonging to a person who tested positive for Pneumonia. FIG. 15B depicts the highlighted GRAD-CAM heat map labeling the important parts of the lung that the model considers to be important for predicting Pneumonia.

FIG. 16A & FIG. 16B are images showing a comparative visualization COVID-19 diagnosis. FIG. 16A depicts an unprocessed X-ray of a lung belonging to a person who tested positive for COVID-19. FIG. 16B depicts an exemplary highlighted GRAD-CAM heat map labeling the important parts of the lung that the model considers to be important for predicting COVID-19.

FIG. 17A, FIG. 17B, FIG. 17C, and FIG. 17D are a series of X-ray images depicting post-training predictions with the actual and predicted labels after training. The diversity of predictions across various conditions demonstrates the model's ability to differentiate between multiple diseases, underscoring its effectiveness in diagnosis.

RAIDER has a scalable architecture with several collaborators working on improving the diagnosis of novel diseases. The deployment choices of an on-premises system were considered for preserving privacy and an edge computing-enabled network. To provide comprehensive insights into the computational complexity, resource requirements, and practical deployment aspects, the performance of training and testing across three distinct categories of devices was evaluated, namely a desktop equipped with a discrete GPU that acts as the far-edge server, a portable and mobile PC (Intel NUC) that acts as the on-premises device, and an IoT device (Raspberry Pi 5) that acts as the near-edge server. As shown by the results of this example, the disclosed ensembling model can be used to quickly identify and diagnose new diseases and improve healthcare delivery during the onset of novel respiratory diseases that the chest radiographs can identify. The expert diagnosis of specialized radiology experts was used, and their expert diagnosis was shared with other physicians across the globe. The models trained on these labeled images are highly accurate at diagnosing respiratory diseases. The disclosed system and method helps deal with the shortage of radiology experts by providing a second opinion to the physicians to enhance the quality and accuracy of their diagnosis. RAIDER also provides high-precision and low-latency diagnosis with minimal system resource requirements. Using this framework enables quick and accurate diagnosis of disease. Using meta-learning, we combined several models developed to diagnose individual diseases were combined, and the predictions for all of the classes of diseases present in our dataset were precisely received without the need for manual weight assignment to the individual models, thereby reducing the bias in the final model. With the evolving needs of the healthcare industry, accurate and efficient diagnosis of diseases is the need of the hour. The disclosed RADIER architecture provides an efficient and cost-effective solution for addressing these needs.
Mehra, Akash, et al., ICASSP 2020-2020 IEEE International Conference on Acoustics, Speech and Signal Processing (ICASSP). IEEE, 2020.
Apple, 2020, Available at: machinelearning.apple.com/research/learning-with-privacy-at-scale
Cormode, Graham, et al. “Privacy at scale: Local differential privacy in practice.” Proceedings of the 2018 International Conference on Management of Data. 2018.
J. Wojtusiak, Y. Wang, V. Vakkalagadda, F. Alemi, and A. Roess, “Using Wi-Fi infrastructure to predict contacts during pandemics,” in PRoc. IEEE 9th Int. Conf Healthcare Informat. (ICHI) August 2021, pp. 347-356.
P. D. Yadav, G. N. Sapkal, R. Ella, R. R. Sahay, D. A. Nyayanit, D. Y. Patil, G. Deshpande, A. M. Shete, N. Gupta, V. K. Mohan, P. Abraham, S. Panda, and B. Bhargava, “Neutralization of beta and delta variant with sera of COVID-19 recovered cases and vaccinees of inactivated COVID-19 vaccine BBV152/Covaxin,” J. Travel Med., vol. 28, no. 7, October 2021, Art. no. taab104.
Y. Wang, P. Tran, and J. Wojtusiak, “From wearable device to Open-EMR: 5G edge centered telemedicine and decision support system,” in Proc. 15th Int. Joint Conf Biomed. Eng. Syst. Technol. (BIOSTEC)—HEALTHINF. Setúbal, Portugal: SciTePress, 2022, pp. 491-498, doi: 10.5220/0010837600003123.
Y. Wang and T. Liao, “Data integrity and causation analysis for wearable devices in 5G,” in Proc. IEEE Int. Conf E-Health Netw., Appl. Services (HealthCom), October 2022, pp. 142-148.
Y. Yi, P. N. P. Lagniton, S. Ye, E. Li, and R.-H. Xu, “COVID-19: What has been learned and to be learned about the novel coronavirus disease,” Int. J. Biol. Sci., vol. 16, no. 10, pp. 1753-1766, 2020.
Y. Wang and J. Wojtusiak, Active Learning Based User-Defined Chest X-ray Diagnosis System Leveraging 5G Infrastructure for COVID-19 Variant Detection. Bethesda, ML, USA: AMIA, 2021.
B. Udugama, P. Kadhiresan, H. N. Kozlowski, A. Malekjahani, M. Osborne, V. Y. C. Li, H. Chen, S. Mubareka, J. B. Gubbay, and W. C. W. Chan, “Diagnosing COVID-19: The disease and tools for detection,” ACS Nano, vol. 14, no. 4, pp. 3822-3835, April 2020.
L. G. B. A. Quekel, A. G. H. Kessels, R. Goei, and J. M. A. van Engelshoven, “Detection of lung cancer on the chest radiograph: A study on observer performance,” Eur. J. Radiol., vol. 39, no. 2, pp. 111-116, August 2001.
F. Shi, L. Xia, F. Shan, B. Song, D. Wu, Y. Wei, H. Yuan, H. Jiang, Y. He, Y. Gao, H. Sui, and D. Shen, “Large-scale screening to distinguish between COVID-19 and community-acquired pneumonia using infection size-aware classification,” Phys. Med. Biol., vol. 66, no. 6, March 2021, Art. no. 065031.
T. Ozturk, M. Talo, E. A. Yildirim, U. B. Baloglu, O. Yildirim, and U. R. Acharya, “Automated detection of COVID-19 cases using deep neural networks with X-ray images,” Comput. Biol. Med., vol. 121, June 2020, Art. no. 103792.
G. Bonito, V. Martinelli, F. Vullo, F. Basilico, E. Polito, A. Izzo, L. Corso, and P. Ricci, “Pictorial guide for variants of COVID-19: CT imaging and interpretation,” BJRj Open, vol. 5, no. 1, November 2023, Art. no. 20220011.
J. Irvin, P. Rajpurkar, M. Ko, Y. Yu, S. Ciurea-Ilcus, C. Chute, H. Marklund, B. Haghgoo, R. Ball, K. Shpanskaya, J. Seekins, D. A. Mong, S. S. Halabi, J. K. Sandberg, R. Jones, D. B. Larson, C. P. Langlotz, B. N. Patel, M. P. Lungren, and A. Y. Ng, “CheXpert: A large chest radiograph dataset with uncertainty labels and expert comparison,” 2019, arXiv:1901.07031.
P. Rajpurkar, J. Irvin, K. Zhu, B. Yang, H. Mehta, T. Duan, D. Ding, A. Bagul, C. Langlotz, K. Shpanskaya, M. P. Lungren, and A. Y. Ng, “CheXNet: Radiologist-level pneumonia detection on chest X-rays with deep learning,” 2017, arXiv:1711.05225.
R. M. Wehbe, J. Sheng, S. Dutta, S. Chai, A. Dravid, S. Barutcu, Y. Wu, D. R. Cantrell, N. Xiao, B. D. Allen, G. A. MacNealy, H. Savas, R. Agrawal, N. Parekh, and A. K. Katsaggelos, “DeepCOVIDXR: An artificial intelligence algorithm to detect COVID-19 on chest radiographs trained and tested on a large U.S. clinical data set,” Radiology, vol. 299, no. 1, pp. E167-E176, April 2021.
I. Drozdov, B. Szubert, E. Reda, P. Makary, D. Forbes, S. L. Chang, A. Ezhil, S. Puttagunta, M. Hall, C. Carlin, and D. J. Lowe, “Development and prospective validation of COVID-19 chest X-ray screening model for patients attending emergency departments,” Sci. Rep., vol. 11, no. 1, p. 20384, October 2021.
I. M. Baltruschat, H. Nickisch, M. Grass, T. Knopp, and A. Saalbach, “Comparison of deep learning approaches for multi-label chest X-ray classification,” Sci. Rep., vol. 9, no. 1, p. 6381, April 2019.
I. D. Apostolopoulos and T. A. Mpesiana, “COVID-19: Automatic detection from X-ray images utilizing transfer learning with convolutional neural networks,” Phys. Eng. Sci. Med., vol. 43, no. 2, pp. 635-640, June 2020.
S. Tabik, A. Gómez-Rios, J. L. Martin-Rodríguez, I. Sevillano-García, M. Rey-Area, D. Charte, E. Guirado, J. L. Suarez, J. Luengo, M. A. Valero-González, P. García-Villanova, E. Olmedo-Sánchez, and F. Herrera, “COVIDGR dataset and COVID-SDNet methodology for predicting COVID-19 based on chest X-ray images,” IEEE J. Biomed. Health Informat., vol. 24, no. 12, pp. 3595-3605, December 2020.
A. E. W. Johnson, T. J. Pollard, S. J. Berkowitz, N. R. Greenbaum, M. P. Lungren, C.-Y. Deng, R. G. Mark, and S. Horng, “MIMIC-CXR, a de-identified publicly available database of chest radiographs with freetext reports,” Sci. Data, vol. 6, no. 1, p. 317, December 2019.
M. de la I. Vayá, J. M. Saborit, J. A. Montell, A. Pertusa, A. Bustos, M. Cazorla, J. Galant, X. Barber, D. Orozco-Beltrin, F. García-García, M. Caparrós, G. González, and J. M. Salinas, “BIMCV COVID-19+: A large annotated dataset of RX and CT images from COVID-19 patients,” 2020, arXiv:2006.01174.
X. P. Burgos-Artizzu, “Computer-aided COVID-19 patient screening using chest images (X-ray and CT scans),” medRxiv, July 2020.
X. Liu, S. C. Rivera, D. Moher, M. J. Calvert, A. K. Denniston, H. Ashrafian, A. L. Beam, A.-W. Chan, G. S. Collins, A. D. J. Deeks, and M. K. ElZarrad, “Reporting guidelines for clinical trial reports for interventions involving artificial intelligence: The CONSORT-AI extension,” Lancet Digit. Health, vol. 2, no. 10, pp. e537-e548, September 2020.
T. Olatunji, L. Yao, B. Covington, A. Rhodes, and A. Upton, “Caveats in generating medical imaging labels from radiology reports,” 2019, arXiv:1905.02283.
E. Çalli, K. Murphy, E. T. Scholten, S. Schalekamp, and B. van Ginneken, “Explainable emphysema detection on chest radiographs with deep learning,” PLoS ONE, vol. 17, no. 7, July 2022, Art. no. e0267539.
L. A. Smith, L. Oakden-Rayner, A. Bird, M. Zeng, M.-S. To, S. Mukherjee, and L. J. Palmer, “Machine learning and deep learning predictive models for long-term prognosis in patients with chronic obstructive pulmonary disease: A systematic review and meta-analysis,” Lancet Digit. Health, vol. 5, no. 12, pp. e872-e881, December 2023.
H. Mahdyoon, R. Klein, W. Eyler, J. B. Lakier, S. C. Chakko, and M. Gheorghiade, “Radiographic pulmonary congestion in end-stage congestive heart failure,” Amer. J. Cardiol., vol. 63, no. 9, pp. 625-627, March 1989.
G. S. Francis, R. Cogswell, and T. Thenappan, “The heterogeneity of heart failure: Will enhanced phenotyping be necessary for future clinical trial success?” J. Amer. College Cardiol., vol. 64, no. 17, pp. 1775-1776, 2014.
S. Chakko, D. Woska, H. Martinez, E. D. Marchena, L. Futterman, K. M. Kessler, and R. J. Myerburg, “Clinical, radiographic, and hemodynamic correlations in chronic congestive heart failure: Conflicting results may lead to inappropriate care,” The Amer. J. Med., vol. 90, no. 1, pp. 353-359, 1991.
X. Wang, Y. Peng, L. Lu, Z. Lu, M. Bagheri, and R. M. Summers, “ChestX-ray8: Hospital-scale chest X-ray database and benchmarks on weakly-supervised classification and localization of common thorax diseases,” in Proc. IEEE Conf. Comput. Vis. Pattern Recognit. (CVPR). Los Alamitos, CA, USA: IEEE Computer Society, July 2017, pp. 3462-3471, doi: 10.1109/CVPR.2017.369. [Online]. Available: doi.ieeecomputersociety.org/10.1109/CVPR.2017.369
A. Kumar, J. Kim, D. Lyndon, M. Fulham, and D. Feng, “An ensemble of fine-tuned convolutional neural networks for medical image classification,” IEEE J. Biomed. Health Informat., vol. 21, no. 1, pp. 31-40, January 2017.
A. Ekbal and S. Saha, “A multiobjective simulated annealing approach for classifier ensemble: Named entity recognition in Indian languages as case studies,” Expert Syst. Appl., vol. 38, no. 12, pp. 14760-14772, November 2011.
J. Prusa, T. M. Khoshgoftaar, and D. J. Dittman, “Using ensemble learners to improve classifier performance on tweet sentiment data,” in Proc. IEEE Int. Conf Inf. reuse Integr., August 2015, pp. 252-257.
X. Dong, Z. Yu, W. Cao, Y. Shi, and Q. Ma, “A survey on ensemble learning,” Frontiers Comput. Sci., vol. 14, pp. 241-258, April 2020.
B. Krawczyk, L. L. Minku, J. Gama, J. Stefanowski, and M. Wozniak, “Ensemble learning for data stream analysis: A survey,” Inf. Fusion, vol. 37, pp. 132-156, September 2017.
O. Sagi and L. Rokach, “Ensemble learning: A survey,” WIREs Data Mining Knowl. Discovery, vol. 8, no. 4, p. e1249, July 2018.
T. B. Chandra, K. Verma, B. K. Singh, D. Jain, and S. S. Netam, “Coronavirus disease (COVID-19) detection in chest X-ray images using majority voting based classifier ensemble,” Expert Syst. Appl., vol. 165, March 2021, Art. no. 113909.
T. Mahmud, M. A. Rahman, and S. A. Fattah, “CovXNet: A multidilation convolutional neural network for automatic COVID-19 and other pneumonia detection from chest X-ray images with transferable multireceptive feature optimization,” Comput. Biol. Med., vol. 122, July 2020, Art. no. 103869.
S. Rajaraman, J. Siegelman, P. O. Alderson, L. S. Folio, L. R. Folio, and S. K. Antani, “Iteratively pruned deep learning ensembles for COVID-19 detection in chest X-rays,” IEEE Access, vol. 8, pp. 115041-115050, 2020.
S. A. B. Ahmad, M. N. Taib, N. E. A. Khalid, R. Ahmad, and H. Taib, “The effect of sharp contrast-limited adaptive histogram equalization (SCLAHE) on intra-oral dental radiograph images,” in Proc. IEEE EMBS Conf Biomed. Eng. Sci. (IECBES), November 2010, pp. 400-405.
E. Whaites and N. Drage, Essentials of Dental Radiography and Radiology. Amsterdam, The Netherlands: Elsevier, 2013.
D. R. Ningsih, “Improving retinal image quality using the contrast stretching, histogram equalization, and CLAHE methods with median filters,” Int. J. Image, Graph. Signal Process., vol. 12, no. 2, pp. 30-41, April 2020.
P. P. Acharjya, S. Mukherjee, and D. Ghoshal, “Digital image segmentation using median filtering and morphological approach,” Int. J. Adv. Res. Comput. Sci. Softw. Eng., vol. 4, no. 1, pp. 552-557, 2014.
H. A. Rahim, A. S. Ibrahim, W. M. D. W. Zaki, and A. Hussain, “Methods to enhance digital fundus image for diabetic retinopathy detection,” in Proc. IEEE 10th Int. Colloq. Signal Process. Appl., March 2014, pp. 221-224.
K. Zuiderveld, “Contrast limited adaptive histogram equalization,” in Graphics Gems IV. New York, NY, USA: Academic, 1994, pp. 474-485.
J. Ma, X. Fan, S. X. Yang, X. Zhang, and X. Zhu, “Contrast limited adaptive histogram equalization-based fusion in YIQ and HSI color spaces for underwater image enhancement,” Int. J. Pattern Recognit. Artif Intell., vol. 32, no. 7, 2018, Art. no. 1854018.
K. B. Khan, A. A. Khaliq, A. Jalil, and M. Shahid, “A robust technique based on VLM and frangi filter for retinal vessel extraction and denoising,” PLoS ONE, vol. 13, no. 2, February 2018, Art. no. e0192203.
A. M. Reza, “Realization of the contrast limited adaptive histogram equalization (CLAHE) for real-time image enhancement,” J. VLSI Signal Process.-Syst. Signal, Image, Video Technol., vol. 38, no. 1, pp. 35-44, August 2004.
H. Ju, D. Lee, S. Kang, and H. Yu, “Mitigating viewpoint sensitivity of self-supervised one-class classifiers,” Inf. Sci., vol. 611, pp. 225-242, 2022, doi: 10.1016/j.ins.2022.08.042. [Online]. Available: sciencedirect.com/science/article/pii/S0020025522009306
A. G. Howard, M. Zhu, B. Chen, D. Kalenichenko, W. Wang, T. Weyand, M. Andreetto, and H. Adam, “MobileNets: Efficient convolutional neural networks for mobile vision applications,” 2017, arXiv:1704.04861.
F. N. Iandola, S. Han, M. W. Moskewicz, K. Ashraf, W. J. Dally, and K. Keutzer, “SqueezeNet: AlexNet-level accuracy with 50× fewer parameters and <0.5 MB model size,” 2016, arXiv:1602.07360.
L. Chaves, A. Bissoto, E. Valle, and S. Avila, “The performance of transferability metrics does not translate to medical tasks,” in Domain Adaptation and Representation Transfer: 5th MICCAI Workshop, DART 2023, Held in Conjunction With MICCAI 2023, Vancouver, BC, Canada, Oct. 12, 2023, Proceedings, vol. 14293, L. Koch, M. J. Cardoso, E. Ferrante, K. Kamnitsas, M. Islam, M. Jiang, N. Rieke, S. A. Tsaftaris, and D. Yang, Eds., Cham, Switzerland: Springer, 2024, pp. 105-114.
E. T. Hassan, X. Chen, and D. Crandall, “Unsupervised domain adaptation using generative models and self-ensembling,” 2018, arXiv:1812.00479.
H. Kim, H. Kim, H. Moon, and H. Ahn, “A weight-adjusted voting algorithm for ensembles of classifiers,” J. Korean Stat. Soc., vol. 40, no. 4, pp. 437-449, December 2011.
R. M. O. Cruz, R. Sabourin, G. D. C. Cavalcanti, and T. I. Ren, “METADES: A dynamic ensemble selection framework using meta-learning,” Pattern Recognit., vol. 48, no. 5, pp. 1925-1935, May 2015.
J. M. Montgomery, F. M. Hollenbach, and M. D. Ward, “Improving predictions using ensemble Bayesian model averaging,” Political Anal., vol. 20, no. 3, pp. 271-291, 2012.
C. Soares, P. B. Brazdil, and P. Kuba, “A meta-learning method to select the kernel width in support vector regression,” Mach. Learn., vol. 54, no. 3, pp. 195-209, March 2004.
S. Kuruvayil and S. Palaniswamy, “Emotion recognition from facial images with simultaneous occlusion, pose and illumination variations using meta-learning,” J. King Saud Univ. Comput. Inf. Sci., vol. 34, no. 9, pp. 7271-7282, October 2022.
A. Mohammed and R. Kora, “A comprehensive review on ensemble deep learning: Opportunities and challenges,” J. King Saud Univ. Comput. Inf. Sci., vol. 35, no. 2, pp. 757-774, February 2023.
X. Wang, Y. Peng, L. Lu, Z. Lu, M. Bagheri, and R. M. Summers, “ChestX-ray8: Hospital-scale chest X-ray database and benchmarks on weakly-supervised classification and localization of common thorax diseases,” in Proc. IEEE Conf. Comput. Vis. Pattern Recognit. (CVPR), July 2017, pp. 2097-2106.
J. Paul Cohen, P. Morrison, and L. Dao, “COVID-19 image data collection,” 2020, arXiv:2003.11597.
D. Kermany, K. Zhang, and M. Goldbaum, “Labeled optical coherence tomography (OCT) and chest X-ray images for classification,” Mendeley Data, vol. 2, no. 2, p. 651, 2018.
S. Jaeger, A. Karargyris, S. Candemir, L. Folio, J. Siegelman, F. Callaghan, Z. Xue, K. Palaniappan, R. K. Singh, S. Antani, G. Thoma, Y.-X. Wang, P.-X. Lu, and C. J. McDonald, “Automatic tuberculosis screening using chest radiographs,” IEEE Trans. Med. Imag., vol. 33, no. 2, pp. 233-245, February 2014.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A method for identifying diseases in real time, comprising:
training an ensemble model to classify disease based on a plurality of lightweight models, wherein each lightweight model is trained to classify an individual disease based on chest x-ray (CXR) imaging;
collecting and anonymizing one or more CXR images of a subject;
labelling the one or more CXR images with one or more expert annotations;
processing the one or more labelled CXR images with an image processing algorithm;
classifying from the processed and labeled CXR images one or more diseases in the subject using the ensemble model;
training an additional lightweight model if an unknown disease is classified;
updating the ensemble model based on the additional lightweight model in real time; and
identifying the unknown disease based on the updated ensemble model.

2. The method of claim 1, wherein the ensemble model uses an adaptive meta-learning ensemble strategy to incorporate the predictions of the lightweight models.

3. The method of claim 2, wherein the ensemble strategy comprises average voting (Avg. Voting), meta-learning approach using logistic regression (ML-LR), and decision trees (ML-DT).

4. The method of claim 1, further comprising the step of anonymizing patient data and sending the CXR images, updated ensemble model, and additional lightweight model to a server comprising a global ensemble model and plurality of global lightweight models when an unknown disease is classified.

5. The method of claim 1, further comprising the step of synchronizing the ensemble model with a server-based ensemble model.

6. The method of claim 1, further comprising the step of synchronizing the plurality of lightweight models with a plurality of server-based lightweight models.

7. The method of claim 1, further comprising the step of alerting a physician when an unknown disease is identified.

8. The method of claim 1, wherein the additional lightweight model comprises geolocation data of the subject.

9. The method of claim 1, further comprising the step of alerting a physician based on geolocation data of the subject or physician when an unknown disease is classified.

10. The method of claim 1, wherein the ensemble model operates on one or more convolutional neural networks (CNNs).

11. A system for identifying disease in real time, comprising:
a first computing device operating one or more models on one or more neural networks, wherein the one or more models comprise a first ensemble model combining the predictions of a first plurality of lightweight models, and wherein each lightweight model is trained to classify an individual disease based on chest x-ray (CXR) imaging;
a second computing device communicatively connected to the first computing device configured to operate one or more models on one or more lightweight neural networks, wherein the one or more models comprise a second ensemble model and second plurality of lightweight models that synchronize with the one or more models of the first computing device, and wherein the second computing device is configured to receive and process labeled CXR images of a subject and classify one or more diseases in the subject with the second ensemble model.

12. The system of claim 11, wherein the second computing device identifies unknown diseases based on the processed labelled CXR images with the second ensemble model, and creates an additional lightweight model for the second plurality of lightweight models based on the classified unknown disease.

13. The system of claim 12, wherein the second computing device sends the CXR images, the updated second ensemble model, and additional lightweight model to the first computing device when an unknown disease is classified.

14. The system of claim 13, wherein the second computing devices anonymizes patient data before synchronizing the models with the first computing device.

15. The system of claim 12, wherein the system alerts a physician based on geolocation data of the subject or physician when an unknown disease is classified.

16. The system of claim 11, further comprising a graphical user interface (GUI) that provides real-time diagnostic data overlaying imaging of the subject.

17. The system of claim 16, wherein the diagnostic data is displayed to a user with highlighted regions of interest on the imaging of the subject.

18. The system of claim 16, wherein the GUI generates a confidence score associated with classification of the one or more diseases, the confidence score indicating a reliability of the classification based on outputs of the plurality of lightweight models.

19. The system of claim 18, wherein the GUI suppresses one or more outputs of the plurality of lightweight models when the confidence score associated with the classification falls below a predetermined threshold.

20. The system of claim 11, wherein the one or more neural networks comprise convolutional neural networks (CNNs).
